(19) United States
(12) Patent Application Publication
(10) Pub. No.: US 2014/0092015 A1
(43) Pub. Date: Apr. 3, 2014

(54) METHOD AND APPARATUS FOR MANIPULATING A GRAPHICAL USER INTERFACE USING CAMERA

(71) Applicant: Zhaohui Xing, Calgary (CA)

(72) Inventor: Zhaohui Xing, Calgary (CA)

(21) Appl. No.: 13/631,863

(22) Filed: Sep. 29, 2012

(51) Int. Cl. G06F 3/033; G06K 9/62

(52) U.S. Cl. 345/158

(57) ABSTRACT

A method and a computing device for manipulating a graphical user interface (GUI) using camera are disclosed. The computing device captures images of a user by using a camera, detects the face image of the user from captured images, and detects at least one facial feature in the face image. The computing device analyzes at least one parameter of one or more facial features to determine gestures.

### FIELD OF THE INVENTION

The subject application relates generally to a method and an apparatus for manipulating a graphical user interface (GUI) using camera.

### BACKGROUND OF THE INVENTION

Computing devices that allow users to manipulate graphic objects presented on a display by using various input devices is known. For example, a desktop computer presents a computer desktop image on a display, which comprises one or more graphic objects such as cursors, icons, windows, menus, toolbars, scrollbars, text input boxes, drop-down menus, text, images, etc., and allows a user to manipulate graphic objects by using a computer mouse or keyboard. A laptop computer also comprises a touchpad. A user may touch one or more fingers on the touchpad to manipulate graphic objects. A tablet or a smartphone comprises a touch-sensitive screen allowing user to directly touch the screen using a pointer (a finger or a stylus) to manipulate graphic object displayed on the screen. Some computing devices may comprise touch input device, e.g., touch-sensitive screen or touchpad, which allows user to inject multiple touch inputs simultaneously.

Other input devices that allow users to manipulate graphic objects are also known. For example, some computers comprise an audio input device such as a microphone to allow users to use voice commands to manipulate graphic objects. Microsoft® Kinect Game console system uses cameras to detect the motion of human body parts, e.g., arms and legs, such that users may use arm gestures to remotely manipulate graphic objects. Other computing devices allowing users to inject input using arm gestures include Nintendo Wii and Sony PlayStation.

The technologies described above have their disadvantages. For example, the input location of keyboard, computer mouse and touch pad does not overlap with the location of the displayed graphic objects, and thus these input devices do not allow users to “directly” manipulate graphic objects. Touch screens require a user to use at least one hand to inject input, which may be a burden in some situations. Using voice commands is not desirable in quiet places, and input devices recognizing arm gestures generally require a large room, and are not suitable for implementing on small-size device such as smartphones, tablets and laptops. It is therefore an object of the present invention to provide a novel method for manipulating graphical objects and a computing device employing the same.

### SUMMARY OF THE INVENTION

Accordingly, in one aspect there is provided a method performed by a computing device for manipulating a graphic object presented on a display, the method comprising: capturing images of a user by using an imaging device; detecting the face image of the user in the captured images; recognizing at least one facial feature in the face image; calculating at least one parameter of said at least one facial feature; and manipulating said graphic object based on the analysis of said at least one parameter of the at least one facial feature.

Depending on the implementation, the imaging device may be located in proximity to the display, or may be integrated with the computing device; the computing device may be a portable computing device, e.g., a phone, tablet, PDA, laptop computer or game console; the facial feature used in the method may be eye, eyebrow, nose, mouth, ear, and/or the combination thereof; and the at least one parameter of the at least one facial feature may be shape, size, angle, position of the at least one facial feature, and/or the combination thereof.

According to another aspect there is provided a method performed by a computing device for manipulating a graphic object presented on a display, the method comprising: capturing images of a user by using an imaging device; detecting the face image of the user in the captured images; calculating at least one parameter of said face image; and manipulating said graphic object based on the analysis of said at least one parameter of said face image.

According to yet another aspect, the method further comprising: detecting the face image of the user in the captured images; recognizing at least one facial feature in the face image; calculating at least one parameter of said at least one facial feature; and manipulating said graphic object based on the analysis of said at least one parameter of said face image and said at least one parameter of the at least one facial feature.

According to still another aspect there is provided a computing device, comprising: an imaging device; a screen; and a processing unit functionally coupling to said imaging device and said screen; said processing unit executing code for displaying on said screen an image comprising a graphic object; instructing said imaging device to capture images of a user; detecting the face image of the user in the captured images; recognizing at least one facial feature in the face image; calculating at least one parameter of said at least one facial feature; and manipulating said graphic object based on the analysis of said at least one parameter of the at least one facial feature.

According to another aspect there is provided a non-transitory computer readable medium having computer executable program for detecting a gesture, the computer executable program comprising: computer executable code for instructing an imaging device to capture images of a user; computer executable code for detecting the face image of the user in the captured images; computer executable code for recognizing at least one facial feature in the face image; computer executable code for calculating at least one parameter of said at least one facial feature; and computer executable code for manipulating said graphic object based on the analysis of said at least one parameter of the at least one facial feature.

### BRIEF DESCRIPTION OF THE DRAWINGS

Embodiments will now be described more fully with reference to the accompanying drawings in which:

FIG. 1 shows a front view of a portable computing device;

FIG. 2 is a schematic block diagram showing the software architecture of the computing device of FIG. 1;

FIG. 3 shows a portion of an exemplary image captured by the camera of the portable computing device of FIG. 1;

FIG. 4 is a flowchart showing the steps performed by the processing unit of a portable computing device for detecting gestures performed by one or more facial features;

FIGS. 5 to 10 illustrate examples of manipulating a graphic object presented on the display according to the method shown in FIG. 4;

FIGS. 11 to 13 illustrate a confirmation gesture performed by blinking one of the user's eyes;

FIGS. 14 to 16 illustrate a rejection gesture performed by blinking the other eye of the user;

FIGS. 17 to 19 show an example of selecting a graphic object by using facial gestures according to an alternative embodiment;

FIGS. 20 and 21 illustrate an example of controlling a value according to yet an alternative embodiment;

FIG. 22 illustrate an example of controlling a value according to still an alternative embodiment;

FIG. 23 shows a front view of a portable computing device according to an alternative embodiment;

FIG. 24 is a schematic block diagram showing the software architecture of the computing device of FIG. 23;

FIG. 25 is a flowchart showing the steps performed by the processing unit of a portable computing device for detecting facial gestures and performing actions by using air stream “touch” point data;

FIGS. 26 to 28 illustrate an example of manipulating a graphic object in the UI of an application program presented on the display according to the method shown in FIG. 25;

FIG. 29 shows a moving gesture according to an alternative embodiment;

FIG. 30 shows a 3D space captured by the camera of a computing device according to yet an alternative embodiment;

FIGS. 31 and 32 show a rotation gesture on the x-y plane by leaning the user's head about the z-axis according to still an alternative embodiment;

FIGS. 33 to 36 show a pitch gesture on the y-z plane by nodding the user's head about the x-axis;

FIGS. 37 to 40 show a yaw gesture on the x-z plane by turning the user's head about the y-axis;

FIGS. 41 and 42 show a zoom gesture performed by moving user's head along the z-axis;

FIGS. 43 to 45 show a moving gesture performed by moving the user's head to different locations in the field of view of the camera;

FIGS. 46 to 48 show another example of a moving gesture performed by moving the user's head to different locations in the field of view of camera;

FIGS. 49 to 52 show a mouth gesture according to yet an alternative embodiment; and

FIGS. 53 to 55 show a move and bubbling ejecting gesture according to still an alternative embodiment.

### DETAILED DESCRIPTION OF THE EMBODIMENTS

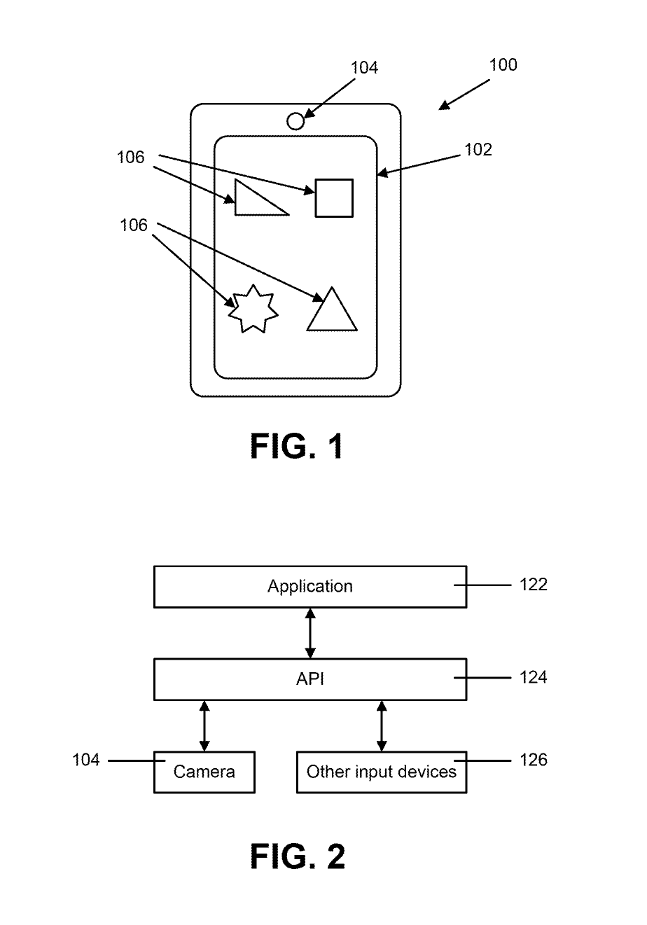

Turning to FIG. 1, a portable computing device 100 is shown, which may be a tablet, smartphone, PDA, game console, or notebook computer. The computing device 100 comprises a screen 102 showing a display image comprising one or more graphic objects 106, a front camera 104 generally facing towards the user, a processing unit (not shown), violate and/or non-violate memory (e.g., a hard disk drive, RAM, ROM, EEPROM, CD-ROM, DVD, flash memory, etc.) and a system bus coupling the various computer components to the processing unit. The computing device 100 may also comprise other components such as HDMI port, Ethernet interface, WiFi interface, Bluetooth interface, universal serial bus (USB) port, FireWire port, etc., depending on the implementation. In this embodiment, the display is a touch-sensitive display capable of detecting pointer (e.g., finger or stylus) contacts applied thereon.

FIG. 2 shows the software architecture of the computing device 100. The software architecture comprises an application layer 122 comprising one or more application programs, and an application programming interface (API) layer 124. The API layer 124 is in communication with the camera 104 and other input devices 126 such as the touch sensitive screen 102, keyboard (not shown) and/or mouse. The API layer 124 is also in communication with the application layer 122 to allow the application layer 122 to control the input devices 104 and 126, and receive input data therefrom.

In this embodiment, an application program in the application layer 122 uses the parameters of one or more detected facial features, such as mouth, eyes, eyebrows, ears, etc., to recognize user gestures. It stores previously detected facial feature parameters, and instructs, via a system facial detection and recognition API in the API layer 124, such as the facial detection and recognition API provided in the Apple iOS or Google Android operation system, the camera 104 to capture images. The camera 104 captures images, and transmits the captured images to the system facial detection and recognition API. The system facial detection and recognition API analyzes the received images and detects the face of a user in front of the computing device 100. It then detects facial features in the face image, and calculates the parameters thereof. The system facial detection and recognition API transmits calculated facial feature parameters to the application program. The application program then compares the received facial feature parameters with the previously detected facial feature parameters stored in the cache. A gesture is recognized if the difference between the received facial feature parameters and the previously detected facial feature parameters is larger than a predetermined threshold. The application program then performs gesture actions, such as scrolling/shifting, zooming in/out, etc., according to the detected gesture to manipulate graphic objects displayed on the screen 102.

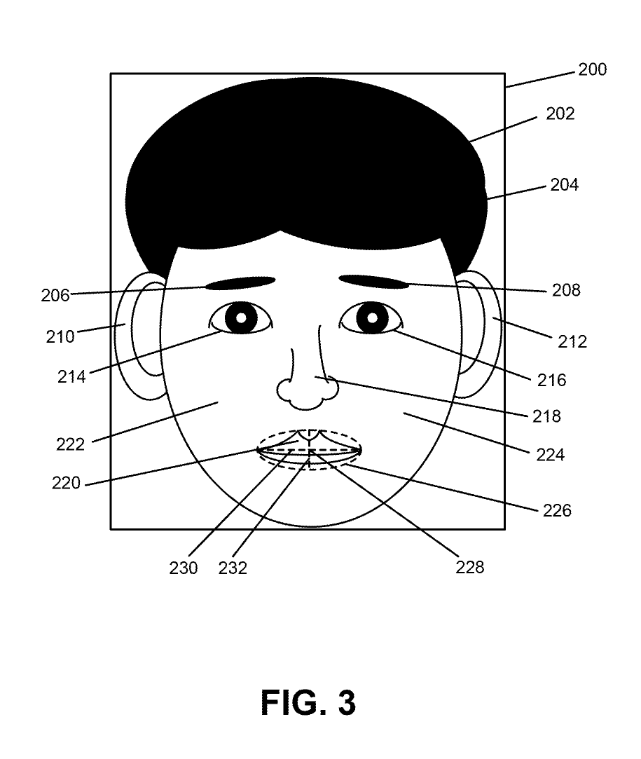

FIG. 3 shows a portion 200 of an exemplary image captured by the camera 104, which comprises the image 202 of a user's face. As can be seen, the user's face image 202 can be characterized by facial features including hair 204, eyebrows 206 and 208, ears 210 and 212, eyes 214 and 216, nose 218, mouth 220, and cheeks 222 and 224. In this embodiment, the face image 202 defines a facial space, and each of the facial features 204 to 224 may be profiled by an appropriate contour in the facial space and described by contour parameters. As those skilled in the art will appreciate, the parameters for profiling facial features may be contour area shape, contour area size, contour area centre point or reference point, etc. As shown in FIG. 3, a contour 226 fitting the mouth 220 in the face image 202 is used characterize the mouth 220. In this example, the mouth contour 226 is modelled as an ellipse having a center point 228, a major axis 230 and a minor axis 232. In this embodiment, different types of facial features (e.g., nose 218 and mouth 220) are characterized by different types of contours, and same type of facial features (e.g. eyes 214 and 216) are characterized by the same type of contour. However, those skilled in the art will appreciate that same type of facial features may be characterized by different types of contours in alternative embodiments. In some other embodiment, each facial feature is characterized by a contour that best fits the facial feature.

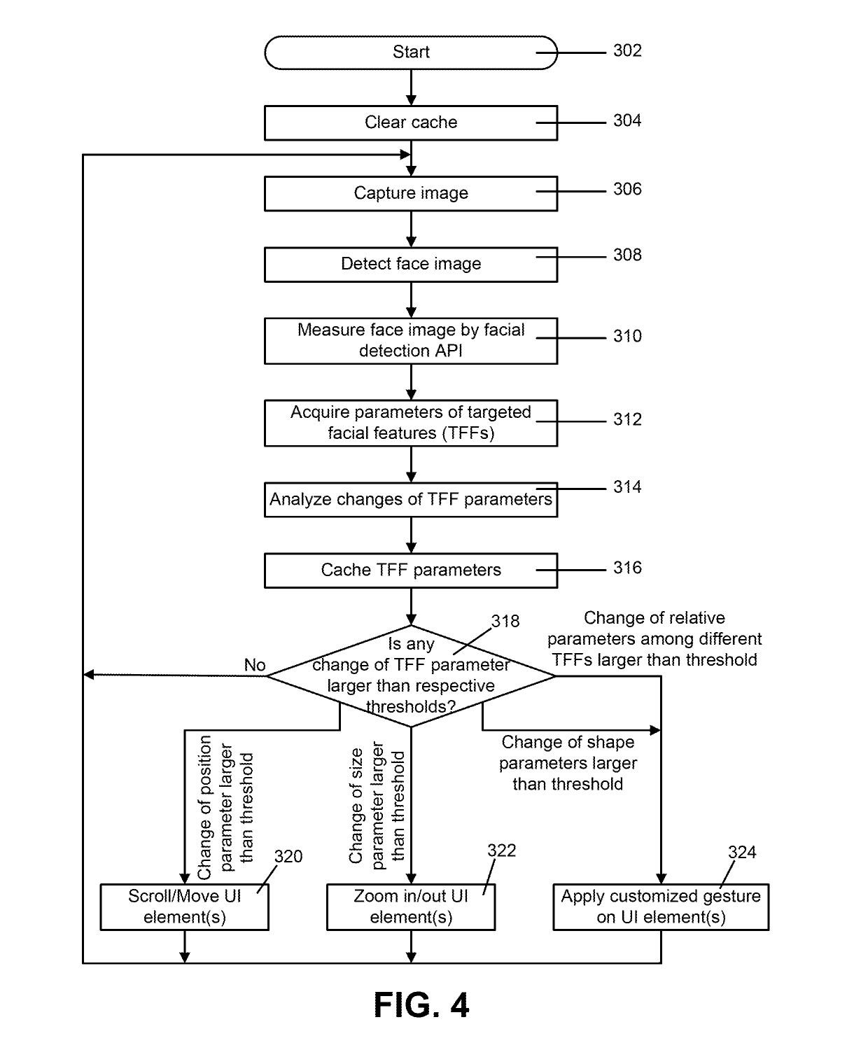

FIG. 4 is a flowchart showing the steps performed by the processing unit for detecting gestures performed by one or more facial features. In this embodiment, a cache is used to store previously detected facial feature parameters.

The process starts when an application program in the application layer 122 is launched, or in some alternative embodiments, when the user of the computing device 100 inputs a command to an application program, e.g., by press a button (not shown) in the Graphic User Interface (GUI) of the application program (step 302). After the process starts, the application clears the cache (step 304). Then the application program informs the system facial detection and recognition API in the API layer 124 the targeted facial features (TFFs), i.e., the facial features that it will use, and instructs, via the system facial detection and recognition API, the camera 104 to capture an image (step 306). In response to the instruction, the camera captures an image, and transmits the captured image to the system facial detection and recognition API. The system facial detection and recognition API processes the received image by, e.g., correcting optical distortion, adjusting image brightness/contrast, adjusting white balance, etc., as needed, and detects a face image therefrom (step 308), and measures the detected face image by using the facial detection API (step 310). A to facial space is then defined based on the detected face image. The system facial detection and recognition API detects the TFFs in the face image, and calculates the parameters of the TFFs as described above (step 312).

The calculated TFF parameters are transmitted to the application program in application layer 122. At step 314, the application program determines the change of TFF parameters by calculating the difference between the TFF parameters it receives from the system facial detection and recognition API with the previously detected TFF parameters that are currently stored in the cache (step 314), and then stores the received TFF parameters in the cache after the change of TFF parameters is determined (step 316).

At step 318, the application program checks if the change of any TFF parameter is larger than the respective predefined threshold, and performs gesture actions accordingly. If no TFF parameter has changed for a degree larger than its corresponding threshold, the process loops back to step 306 to capture another image.

If at step 318, it is determined that the change of the position parameter is larger than the predetermined position-change threshold, the application program then performs a scrolling or moving gesture by scrolling or moving one or more graphic objects displayed on the screen 102 (step 320). Here, the graphic objects may be text, image, buttons, menus, graphic cursor, etc., which may be moved within a predetermined area. Depending on the implementation, the predetermined area may be, e.g., a canvas, a window, a document, etc. The predetermined area may also be, e.g., a scrollbar that the scrolling block may be scrolled therein, or an area larger than the display (e.g., a graphic gaming zone) that a graphic object may be moved beyond the currently displayed area. The process then loops back to step 306 to capture another image.

If at step 318, it is determined that the change of the size parameter is larger than the predetermined size-change threshold, the application program then performs a zooming gesture to the graphic objects displayed on the screen 102 (step 322). As will be shown in more detail later, if the size of the TFF is reduced, the application program performs a zoom-out gesture by reducing the size of the graphic objects; if the size of the TFF is increased, the application program performs a zoom-in gesture by increasing the size of the graphic objects. The process then loops back to step 306 to capture another image.

Other gestures are also readily available. For example, if at step 318, it is determined that the change of the shape parameter is larger than the predetermined shape-change threshold, the application program then performs a user-defined gesture to the graphic objects displayed on the screen 102 (step 324), which will be described in more detail later. The process then loops back to step 306 to capture another image.

If at step 318, it is determined that the change of the relative parameters among different TFFs is larger than a predetermined threshold, the application program then performs another user-defined gesture to the graphic objects displayed on the screen 102 (step 324). The process then loops back to step 306 to capture another image.

The process thus repeats the steps described above until a command for stopping the process is received from the user (e.g., the user terminates the execution of the application program, or a “Stop” button (not shown) in the application program user interface (UI) is pressed).

The steps shown in FIG. 4 are for illustrative purpose only. Those skilled in the art will appreciate that modifications to the process, such as adding or removing one or more steps, or changing the order of some steps may occur in various embodiments depending on the implementation. The gestures (steps 320, 322 and 324) listed therein are also for illustrative purpose only, and does not mean to be exhaustive. For example, although not shown in FIG. 4, if at step 318, it is determined that the angle of one or more facial features is change by an amount larger than a predetermined threshold, a rotation gesture may be determined, and in response to the rotation gesture, the application program rotates one or more UI elements.

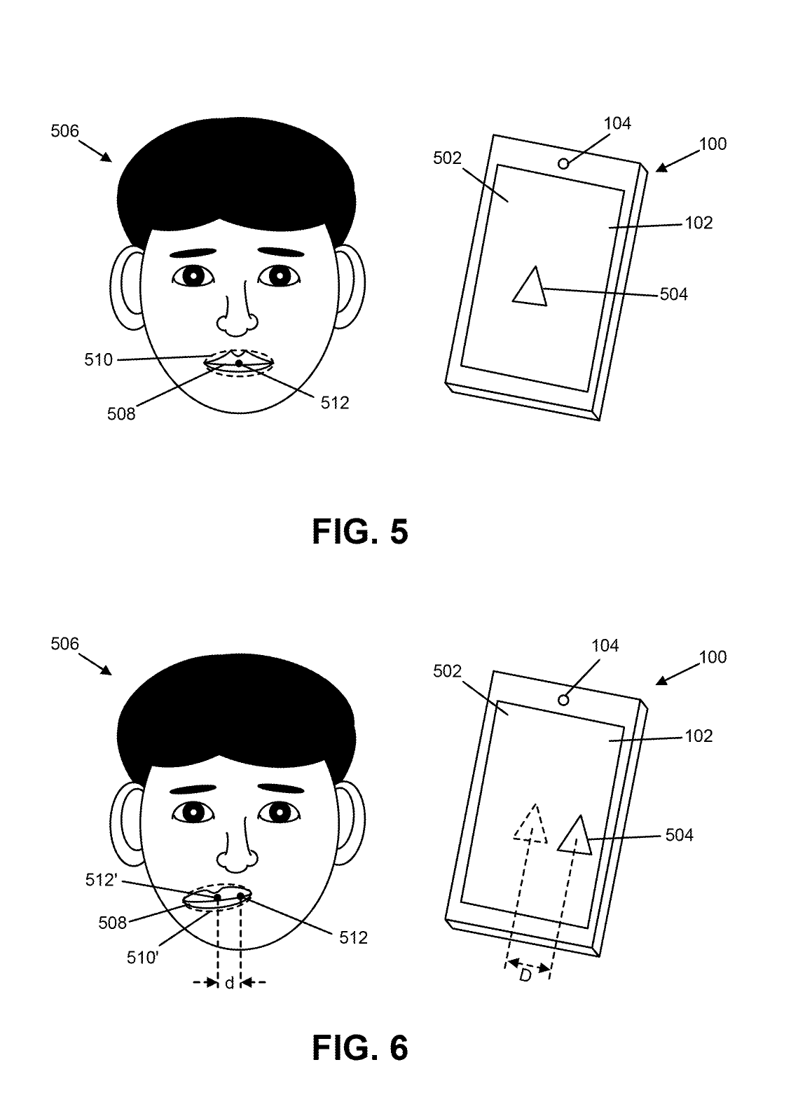

FIGS. 5 to 10 illustrate examples of manipulating a graphic object in the UI of an application program presented on the display according to the method shown in FIG. 4. In these examples, the computing device 100 runs an application program which presents an UI 502 comprising a graphic object 504 on the screen 102. A user 506 is facing the screen 102 of the computing device 100, and uses the mouth 508 to manipulate a graphic object 504.

FIGS. 5 to 7 illustrate a horizontal scrolling/moving gesture performed by the user 506 using his mouth 508. As shown in FIG. 5, the user 506 locates his mouth 508 at a first position, e.g., the center position, and commands the application program to start manipulating the graphic object 504 by pressing a button (not shown) in the UI 502. Following the process shown in FIG. 4, the application program clears the cache (step 304). Then the application program informs the facial detection and recognition API the TFF, which is the mouth in these examples, and instructs via the system facial detection and recognition API, the camera 104 to capture an image (step 306). The camera 104 in response captures the image of the user, and transmits the captured image to the system facial detection and recognition API. The system facial detection and recognition API processes the received image as needed, and detects a face image therefrom (step 308). The system facial detection and recognition API measures the detected face image by using a facial detection API to define the facial space (step 310), and then detects the TFF, i.e., the mouth 508, in the face image. As described before, the mouth 508 is profiled by an ellipse 51( ) having a center point 512. The system facial detection and recognition API then calculates the size and position parameters of the mouth by calculating the size and center position of the mouth's profile ellipse (step 312). The size and position parameters of the mouth are sent to the application program. The application program check if any change of the size and position parameters of the mouth has occurred (step 314) and then stores the received size and position parameters of the mouth into the cache (step 316). As no previously detected facial feature is available, the process loops to step 306 to capture another image.

Following this process, the application program thus monitors the user's face to detect any gesture performed by the user's mouth. As shown in FIG. 6, the user 506 moves his mouth 508 to his right. The camera 104 captures an image of the user at step 304. Following steps 306 to 324, the system facial detection and recognition API detects the mouth from the captured image, calculates the size and position parameters of the profile ellipse 510′ of the mouth 508, and sends the parameters to the application program. The application program compares the position of the center 512′ of the profile ellipse 510′ with that of the stored center 512 of the profile ellipse 510, and determines at step 318 that the position of the mouth has moved towards the user's right side for a distance d that is larger than a predefined mouth-position-change threshold. The application program thus determines that a horizontal scrolling/moving gesture has been performed by the user's mouth. In this embodiment, the direction of horizontally moving a graphic object is defined as the opposite direction of the mouth's movement. Therefore, in response to the horizontal scrolling/moving gesture performed by the user's mouth, the application program moves the graphic object 504 towards the left side of the screen 102 for a distance D that is proportional to the distance d that the mouth 508 has moved, i.e.,

D=c₁d,

where c₁ is a nonzero ratio defined in the application program. The current mouth position 512′ and size are stored in the cache for future use.

The ratio c₁ may be predefined in the application program, or alternatively, be determined by the application program. For example, in one embodiment, the application program is a video game displaying a graphic image representing a game role in a large-size gaming area, a large c1 may be used by the application program to allow the user to move a graphic image in a fast pace by using facial gestures. In another embodiment, the application program is an e-book reader that allows user to scroll text using facial gestures. In this embodiment, the application program may use a small ratio c₁ to allow the user scroll text in a comfortable speed.

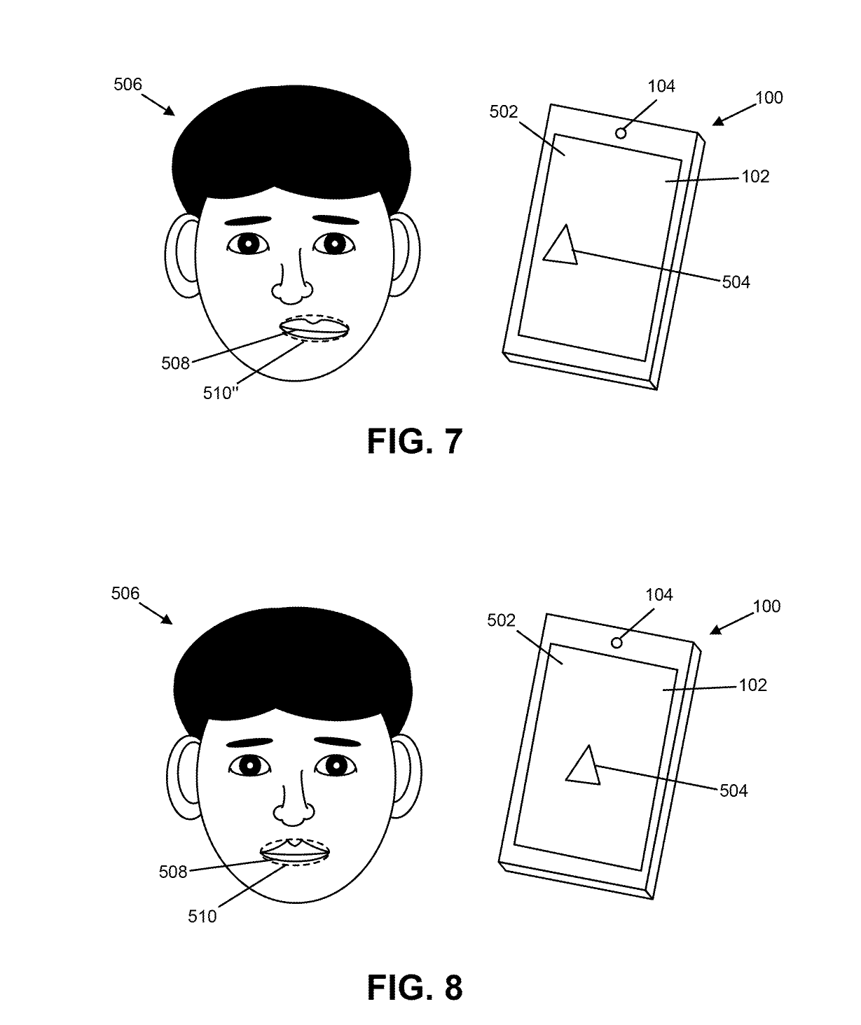

As shown in FIG. 7, the user moves his mouth towards his left, the application program recognizes this horizontal scrolling/moving gesture from the image captured by the camera 104 by comparing the position of the profile ellipse 510″ with that of the stored profile ellipse to recognize the gesture. In response to the recognized gesture, the application program moves the graphic object 504 towards the right side for a distance proportional to the distance that the mouth 508 has moved.

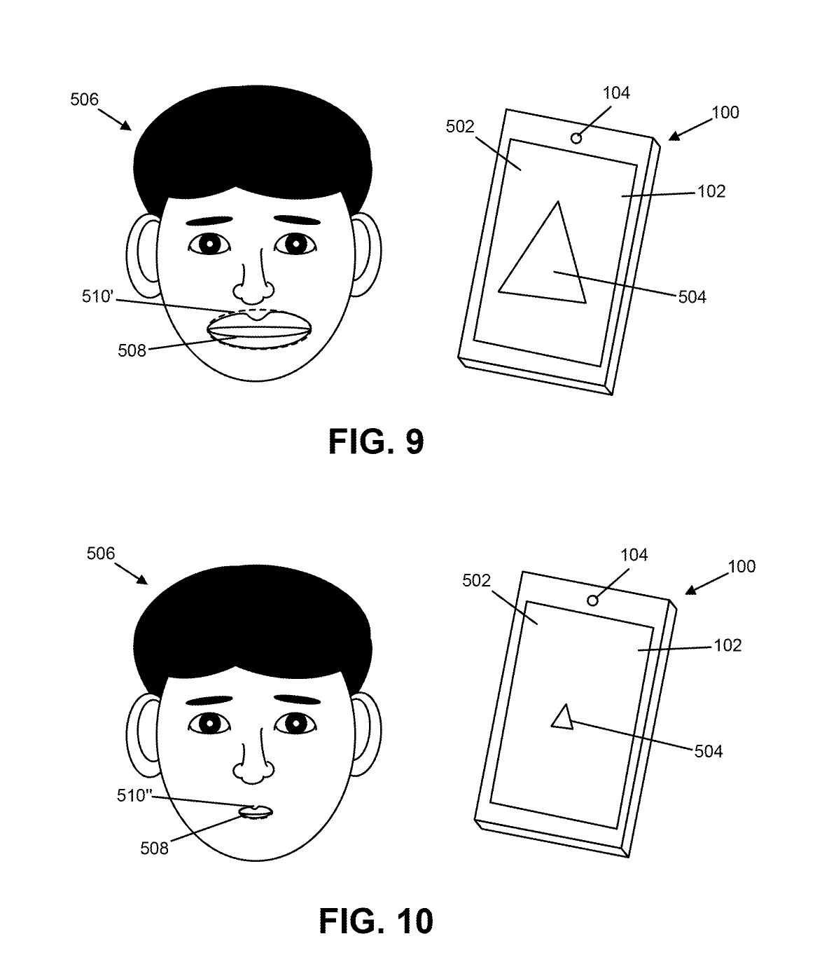

FIGS. 8 to 10 illustrate a zooming gesture performed by the user 506 using his mouth 508. As shown in FIG. 8, the user 506 rests his mouth 508 with a first size, e.g., the normal size. Following the process in FIG. 4, the camera 104 to capture an image of the user 506. The system facial detection and recognition API detects the mouth 508 from the captured image, calculates the size s and position parameters of the profile ellipse 510, and sends the parameters to the application program for the application program to track the change of the size of the mouth 508. As shown in FIG. 9, the user 506 opened his mouth 508. The camera 104 captures an image of the user. The system facial detection and recognition API then recognizes the mouth 508 from the captured image, calculates the size s′ and position parameters of the profile ellipse 510′, and sends the parameters to the application program. The application program compares the received size s′ with the stored size s, and determines that their difference (s′/s) is larger than a predetermined size-change threshold. As a result, a zoom-in gesture is detected, and the application program in response to the gesture proportionally zooms the graphic object 504 to a size S′ that

S′=c₂Ss′/s,

where S′ represents the size of the graphic object 504 after zooming, S represents the size of the graphic object 504 before zooming, and c₂ is a nonzero ratio determined by the application program. The current mouth position and size s′ are stored in the cache for future use.

Similarly, as shown in FIG. 10, the user shrinks his mouth 508 to perform a zoom-out gesture. The application program recognizes this gesture from the image captured by the camera 104 by comparing the size of the profile ellipse 510″ with that of the stored profile ellipse to recognize the gesture. In response to the recognized gesture, the application program proportionally zooms out the graphic object 504 to a smaller size.

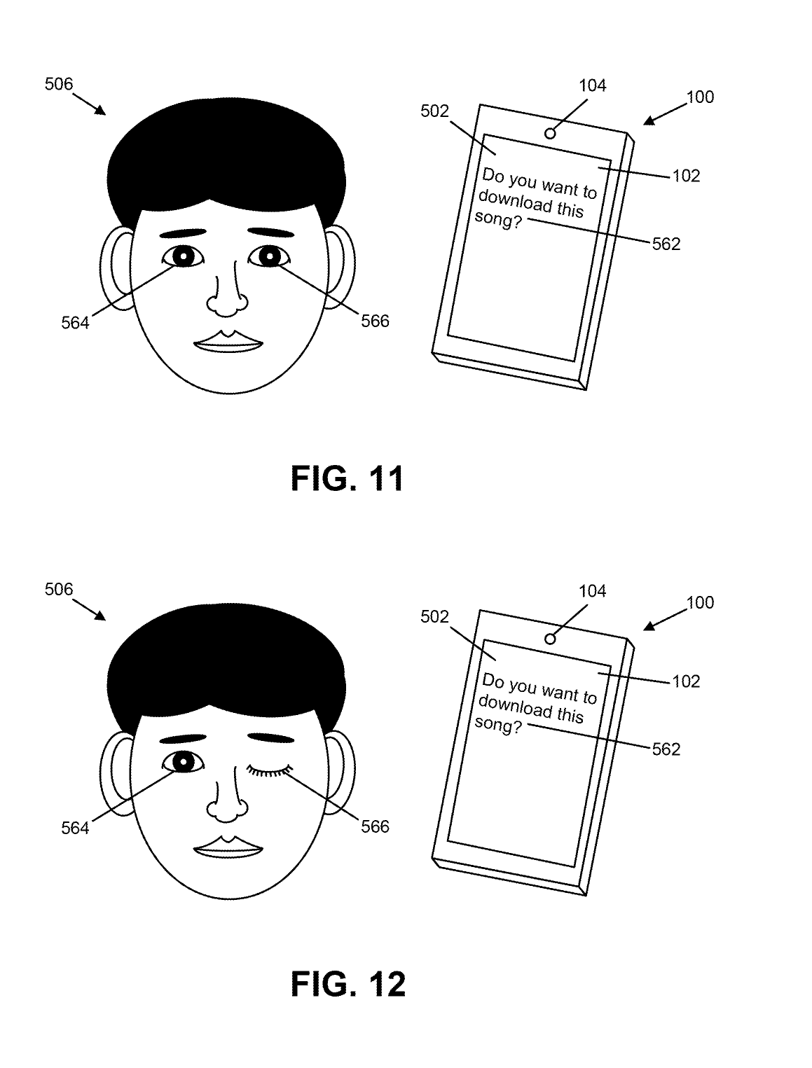

FIGS. 11 to 13 illustrate a confirmation gesture performed by blinking an eye, which in this embodiment is predefined as the user's left eye. As shown in FIG. 11, an application program displays a question 562 in its UI 502 shown on the screen 102, and waits for the user 506 to provide an input using his eyes. Following the method in FIG. 4, the application detects the size and shape of the eyes 564 and 566, respectively, from the images captured by the camera 104.

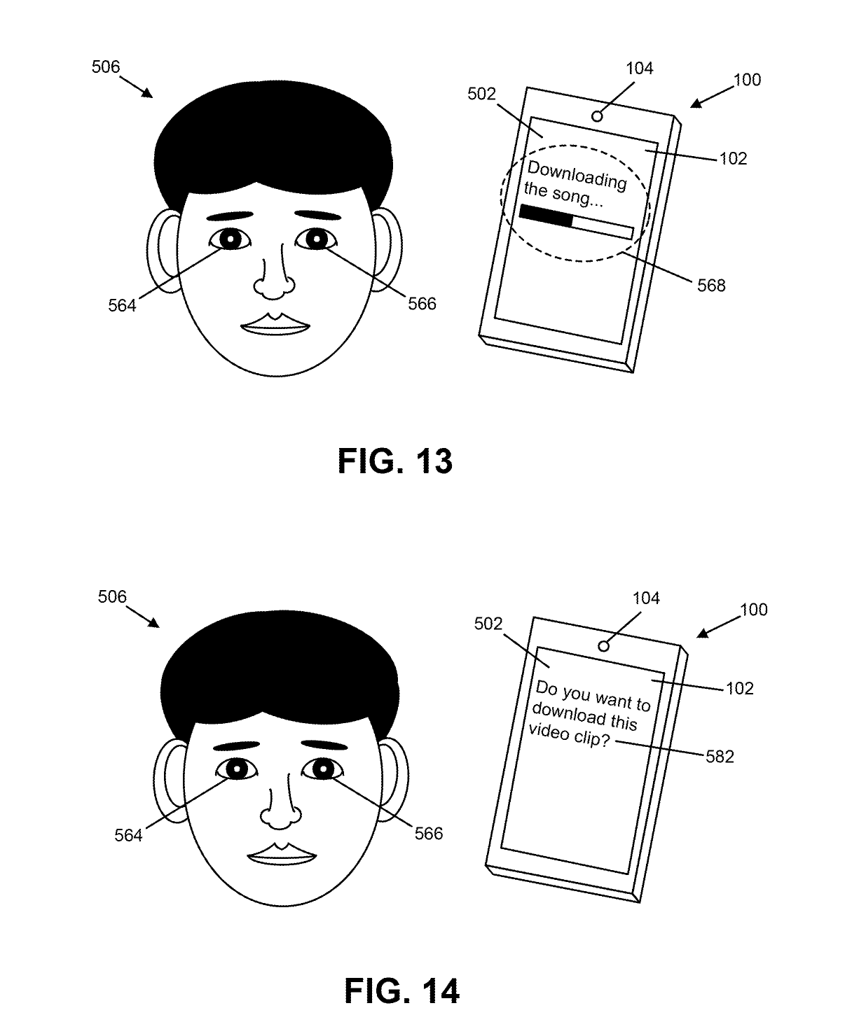

As shown in FIG. 12, the user closes his left eye 566 for at least a predetermined period of time, e.g., one (1) second. The application program detects the shape-change of the user's left eye 566. After a predetermined period of time has passed while the left eye 566 is still close, the application program then determines that a confirmation gesture has been performed for providing a positive answer to the question 562. As shown in FIG. 13, after the user opens his left eye 566, the application program starts the task that is associated with the question 562, and displays an indication 568.

FIGS. 14 to 16 illustrate a rejection gesture performed by blinking the other eye, which is predefined as the user's right eye in this embodiment. As shown in FIG. 14, an application program displays a question 582 in its UI 502 shown on the screen 102, and waits for the user 506 to provide an input using his eyes. Following the method in FIG. 4, the application detects the size and shape of the eyes 564 and 566, respectively, from the images captured by the camera 104.

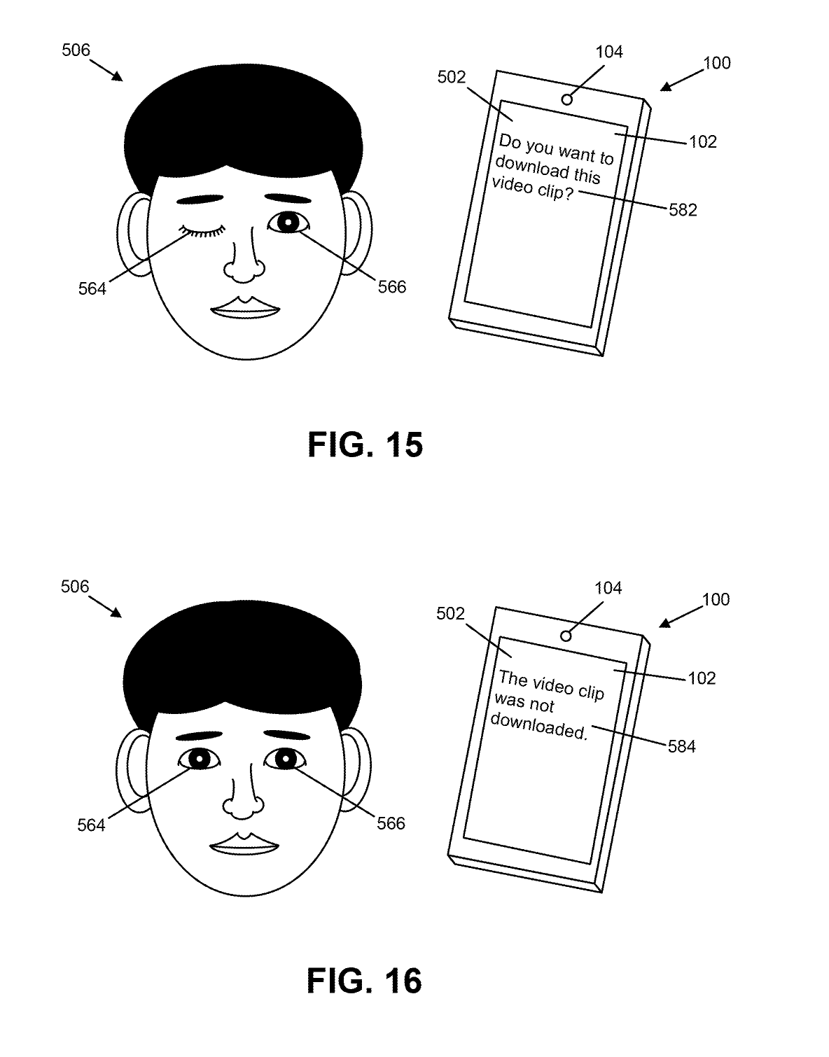

As shown in FIG. 15, the user closes his right eye 564 for at least a predetermined period of time, e.g., one (1) second. The application program detects the shape-change of the user's right eye 564. After a predetermined period of time has passed while the right eye 564 is still close, the application program then determines that a rejection gesture has been performed for providing a negative answer to the question 582. As shown in FIG. 16, after the user opens his right eye 564, the application program cancels the task that is associated with the question 582, and displays an indication 584.

Those skilled in the art will appreciate that other gestures are also readily available by using one or more facial features. For example, in an alternative embodiment, an eye blinking once may be detected and recognized as a confirmation input, and an eye blinking twice within a predetermined period of time may be detected and recognized as a rejection input. In another embodiment, blinking one eye may be detected and recognized as a confirmation input, and blinking two eyes simultaneously may be detected and recognized as a rejection input. In yet another embodiment, moving mouth while an eye is closed may be detected and recognized as a gesture for nudging a graphic object to the opposite direction of mouth movement for a small distance. In still another embodiment, the application program allows users to define their own gestures for one or more facial features.

Although the method in FIG. 4 is described as only using camera 104 to detect gestures, in some alternative embodiments, the facial features captured by the camera 104 and the pointer contacts on the display detected by the touch sensitive screen 102 are combined for recognizing gestures performed by the facial features and the graphic objects selected by the pointer contacts on the display. In some other embodiments, gestures may be performed by one or more facial features together with one or more pointer contacts on the display. For example, mouth moving towards a direction while a pointer contact moving towards the opposite direction may be defined as a zoom-in gesture.

Although the computing device 100 described above comprises a touch sensitive display, in some alternative embodiments, the display does not have touch detection capability.

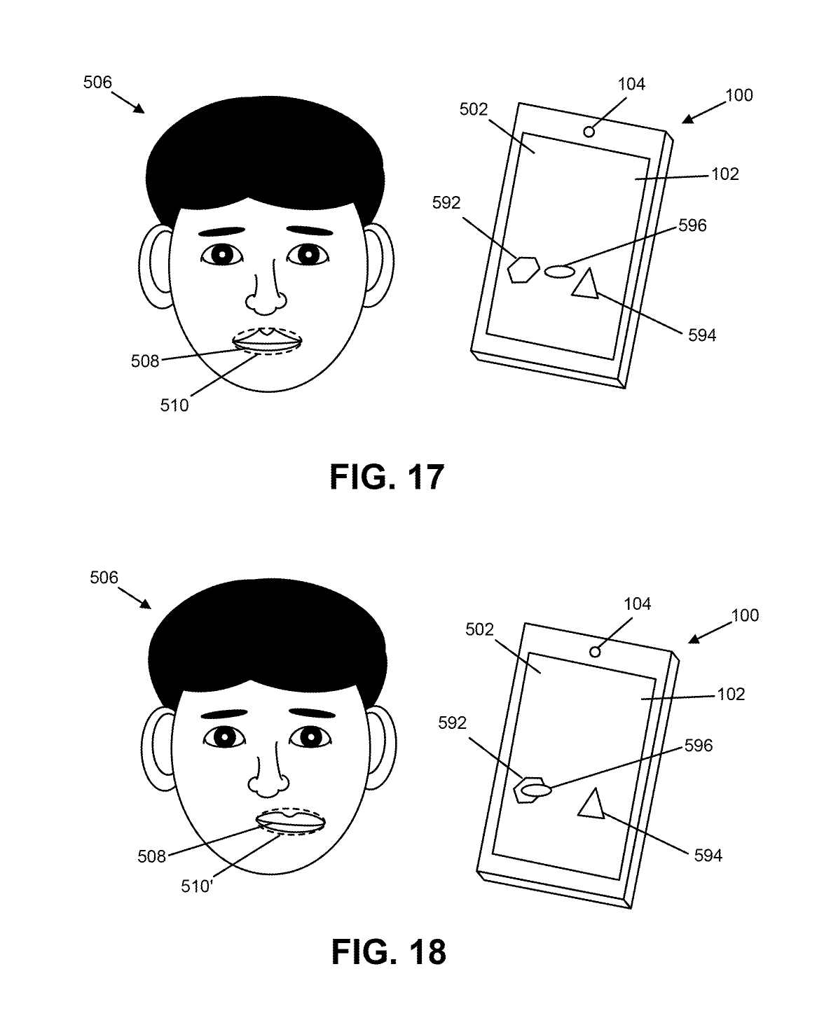

In above examples, the application program displays a graphic object on the display for user to manipulate using facial gestures. In some alternative embodiments, the user may use facial gesture to select one or more graphic objects that are presented on the display. FIGS. 17 to 19 show an example of selecting a graphic object by using facial gestures.

As shown in FIG. 17, an application program displays two graphic objects 592 and 594, and a cursor 596 in its UI 502 shown on the screen 102. The user 506 uses facial gestures to control the cursor 596 to select a graphic object.

Shown in FIG. 18, the user 506 moves his mouth 508 to his left. By calculating the position of the mouth contour 510′, the application program detects the mouth movement, and determines that a mouth move gesture is performed. In response to the mouth move gesture, the application program moves the cursor 596 to the left side. In this way, the user uses mouth move gesture to move the cursor 596 to a position at least partly overlapping the graphic object 592.

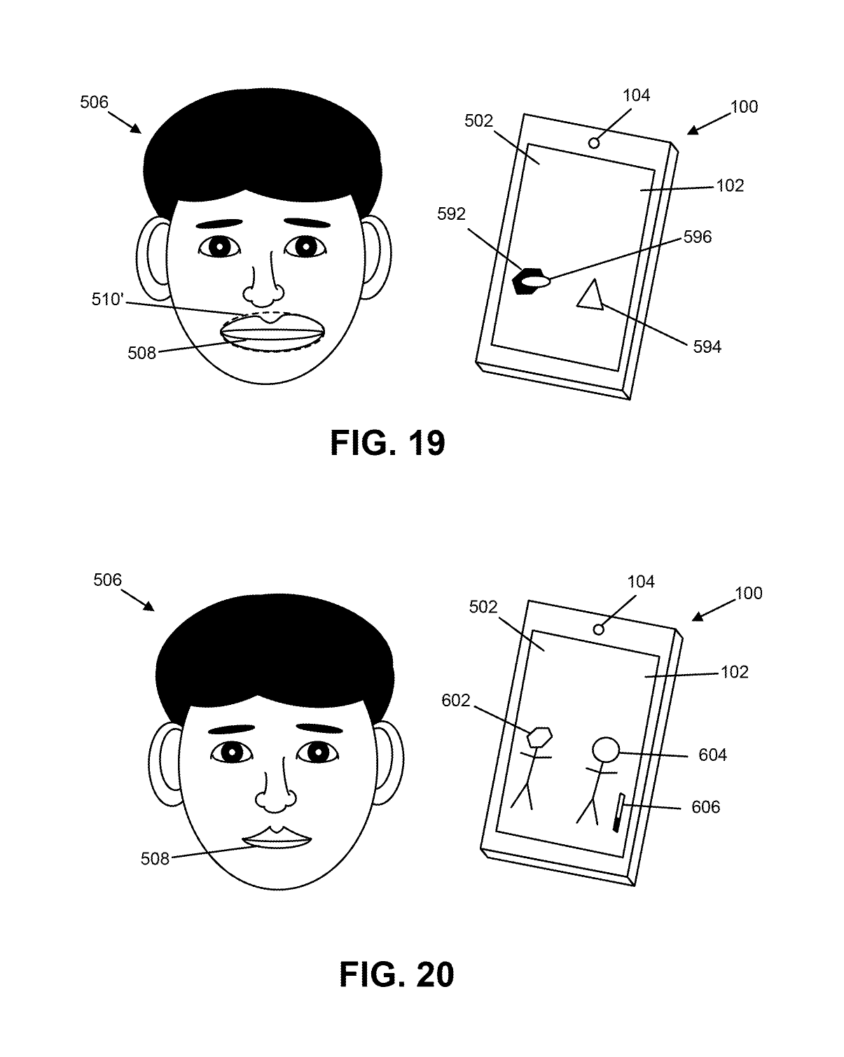

As shown in FIG. 19, after the cursor 596 is moved over the graphic object 592, the user 506 opens his mouth 508 to perform a mouth selection gesture. The application program detects the mouth selection gesture, and in response, selects the graphic object 592 that the cursor 596 overlaps thereon. In this embodiment, the graphic object 592 is highlighted to indicate that it has been selected.

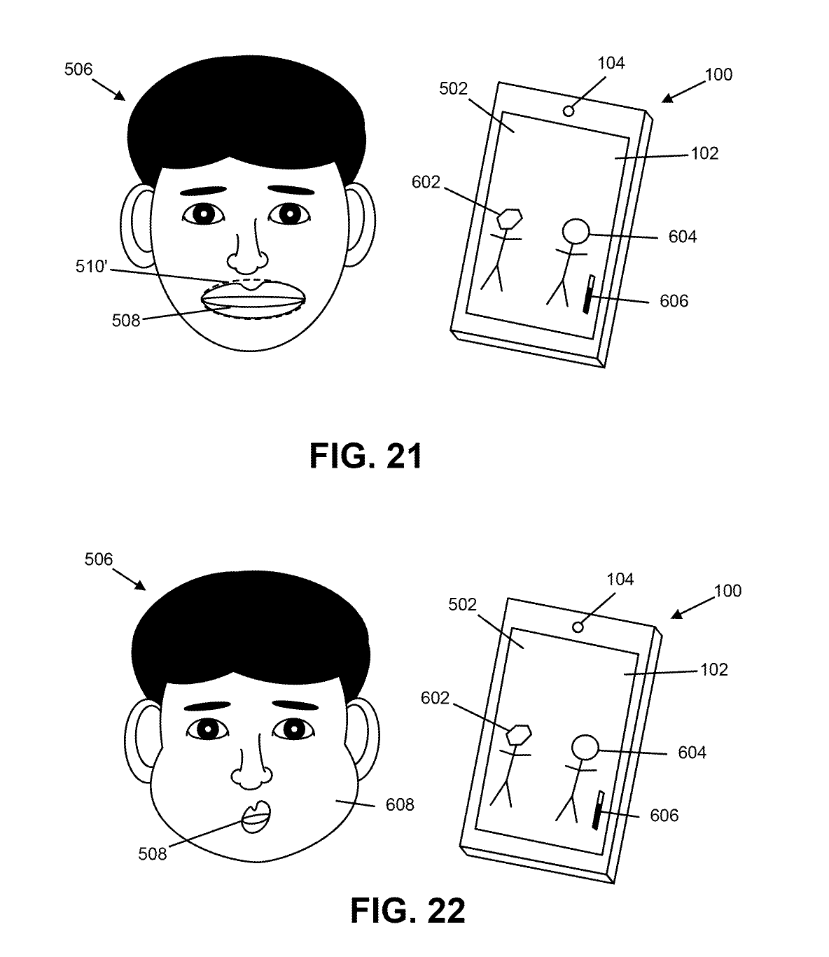

Those skilled in the art will appreciate that facial gestures may be used to inject various user inputs. FIGS. 20 and 21 illustrate an example of an alternative embodiment. In this embodiment, an application program displays two graphic objects 602 and 604 representing two game characters in competition. Here, the application program controls the character 602, and the user controls the character 604. A strength bar 606 indicating the “strength” of the character 604 is also displayed on the UI 502 shown on the screen 102.

The user 506 uses his mouth 508 to control the strength bar 606 to adjust the “strength” of the character 604. As shown in FIG. 21, the user 506 opens his mouth 508 to increase the “strength” value. The application program detects the mouth open gesture, and in response increases the “strength” value of the character 604. The increase of “strength” value is indicated by the increased level (shown as the increased dark portion in the strength bar 606) in the strength bar 606.

Other facial gestures may alternatively be used for adjusting a value such as the “strength” value of a character. For example, as shown in FIG. 22, the user 506 uses his mouth 508 and cheek 608 to perform a gesture controlling the strength bar 606. In this embodiment, the application program detects the shape change of the user's mouth 508 and cheek 608. If the user's cheek 608 has expanded and the shape of the mouth 508 has changed to a substantially round shape, the application program then increases the “strength” value of the strength bar 606.

Those skilled in the art will appreciate that, although in above examples the application program moves the one or more graphic objects to an opposite direction (with respect to the device) of the facial move gesture direction (with respect to the user) such that the graphic objects are effectively moving to the same direction from the user's perspective, in some alternative embodiments, the application program may move the graphic objects to the same direction (with respective to the device) of the facial move gesture direction (with respect to the user) such that the graphic objects are effectively moving to the opposite direction from the user's perspective. In some other embodiments, the user may use facial move gestures to move one or more graphic objects to other directions, e.g., a vertical direction.

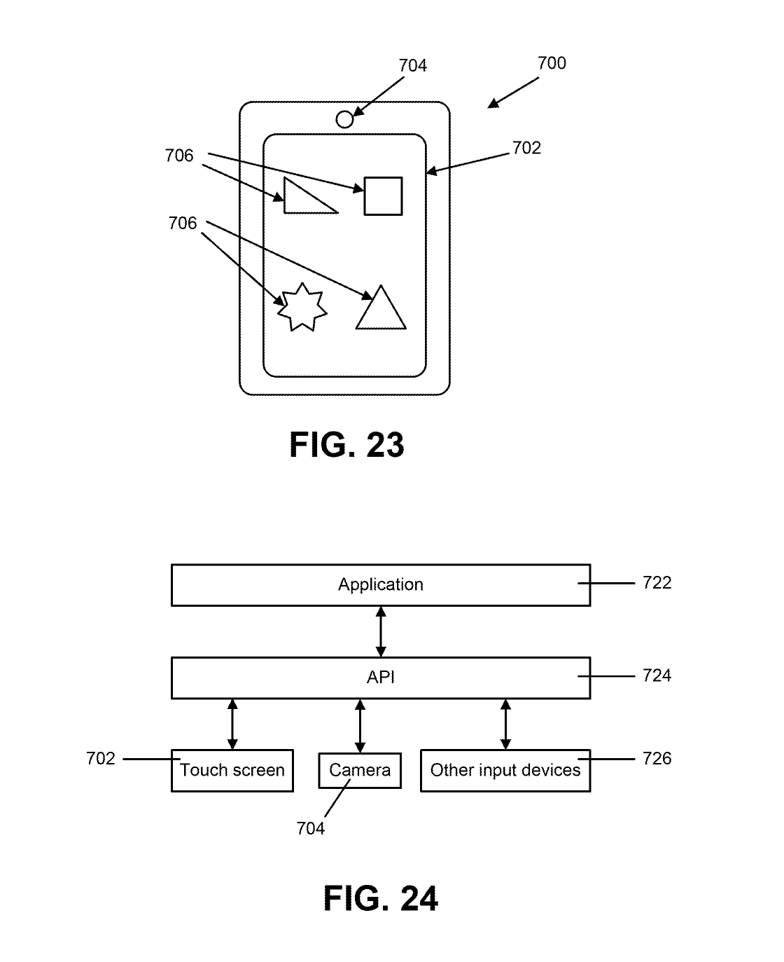

Those skilled in the art will appreciate that other methods for manipulating graphic objects are also readily available. FIG. 23 shows a portable computing device 700 according to an alternative embodiment. Similar to the computing device 100 in FIG. 1, the computing device 700 comprises a touch sensitive display 702 displaying one or more graphic objects 706, and a camera 704. In this embodiment, the touch sensitive screen comprises a capacitive grid capable of detecting an air or vapour stream applied thereto, such as the touch sensitive film described in PCT Patent Publication Number WO/2011/03971, entitled “METHOD AND DEVICE FOR HIGH-SENSITIVITY MULTI POINT DETECTION AND USE THEREOF IN INTERACTION THROUGH AIR, VAPOUR OR BLOWN AIR MASSES” to REIS BARBOSA, et al., filed on Sep. 29, 2010, the content of which is incorporated herein by reference in its entirety.

FIG. 24 shows the software architecture of the computing device 700. The software architecture comprises an application layer 722 comprising one or more application programs, and an application programming interface (API) layer 724. The API layer 724 is in communication with the touch sensitive display 702, the camera 704 and other input devices 726 such as keyboard (not shown) and/or mouse. The API layer 724 is also in communication with the application layer 722 to allow the application layer 722 to control the input devices 702, 704 and 726, and receive input data therefrom.

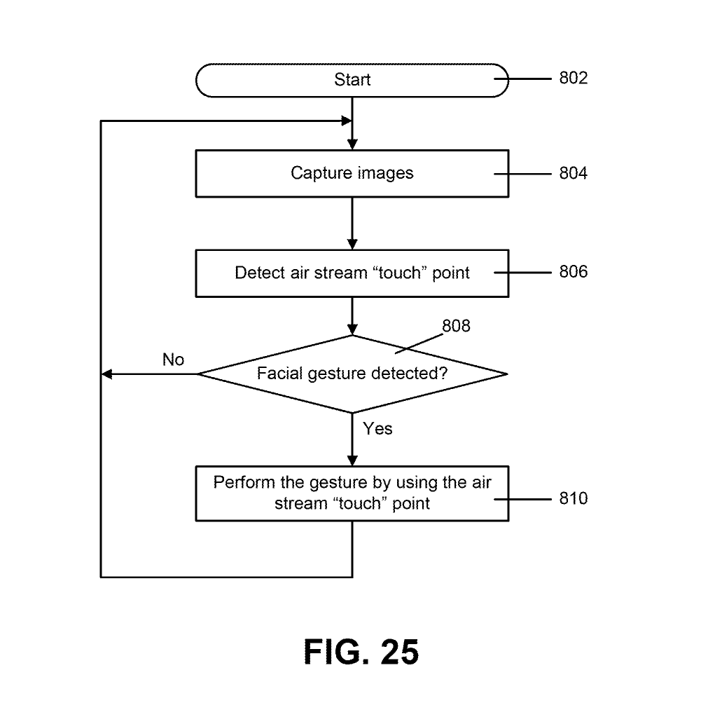

FIG. 25 is a flowchart showing the steps performed by the processing unit of a portable computing device for detecting facial gestures and performing actions by using air stream “touch” point data. The process starts when an application program in the application layer 722 is launched, or in some alternative embodiments, when the user of the computing device 700 inputs a command to an application program, e.g., by press a button (not shown) in the GUI of the application program (step 802). After the process starts, the application program instructs the camera 704 to capture images (step 804), and communicates with the touch sensitive display 702 to detect the position of the air stream (if any) “contacting” the touch sensitive display 702, i.e., the air stream “touch” point (step 806). At step 808, the application program detects a gesture performed by one or more facial features as described above. If no facial gesture is detected, the process loops to step 804 to capture another image. If at step 808, a facial gesture performed by one or more facial features is detected, the application program in response performs actions associated with the gesture by using the position of the air stream “touch” point (step 810). The process then loops to step 804.

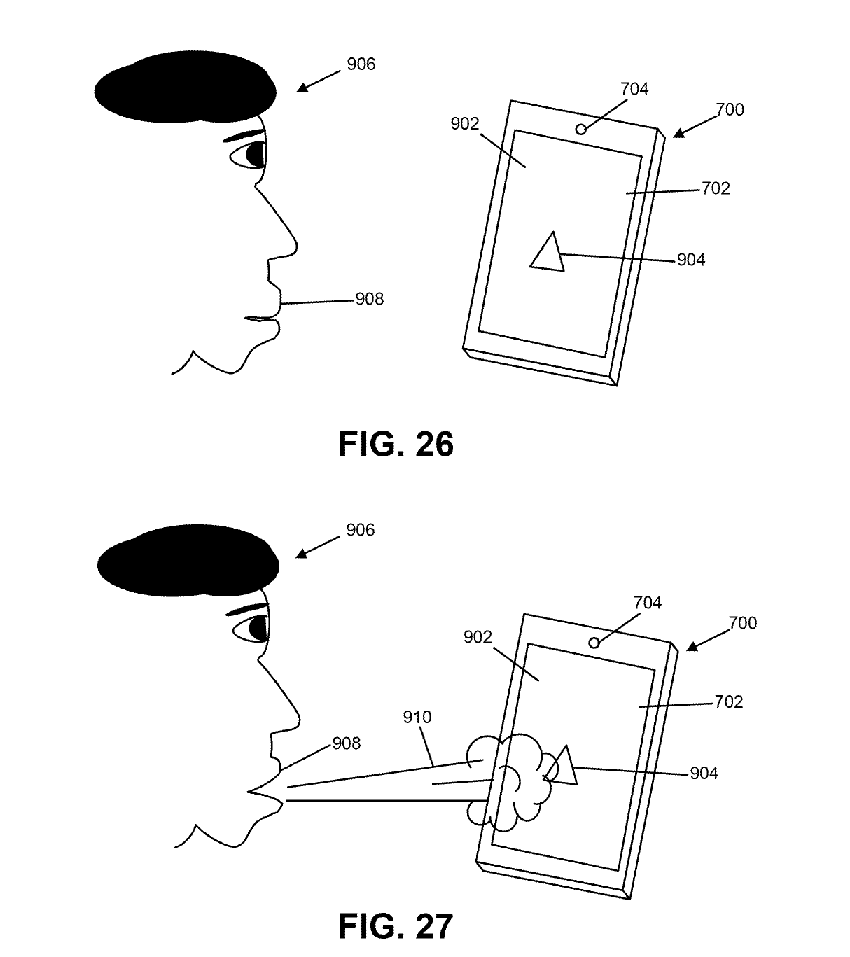

FIGS. 26 to 28 illustrate an example of manipulating a graphic object in the UI of an application program presented on the display according to the method shown in FIG. 25. In this example, the computing device 700 runs an application program which presents an UI 902 comprising a graphic object 904 on the display 702. A user 906 is facing the display 702 of the computing device 700, and uses his mouth 908 to manipulate a graphic object 904.

As shown in FIG. 26, the user 906 closes his mouth 908, and commands the application program to start manipulating the graphic object 904 by pressing a button (not shown) in the UI 902. Following the process shown in FIG. 25, the application program instructs, via the system facial detection and recognition API in the API layer 724, the camera 704 to capture an image. The system facial detection and recognition API detects the mouth 908 from the captured image, and calculates the shape, size and position parameters of the mouth 908, and sends the calculated parameters to the application program.

As shown in FIG. 27, the user opens his mouth 908 and blows an air stream 910 towards the graphic object 904 presented on the display 702. Following the process in FIG. 25, the camera 704 captures an image, and the system facial detection and recognition API calculates the parameters of the mouth from the captured image, and sends them to the application program. The application program compares the size parameter of the mouth with that stored in the cache, and determined that the size change is larger than a predefined threshold. As a result, a scrolling/moving gesture is recognized. The application program also communicates with a touch detection API in communication with the touch sensitive display 702 to detect any air stream projected to the surface of the touch sensitive display 702, and calculates the position that the air stream is projected thereto. After the position of the air stream “touch” point is calculated, the application program determines that the air stream “touch” point overlaps with the location of the graphic object 904, and associates the graphic object 904 with the scrolling/moving gesture to be performed.

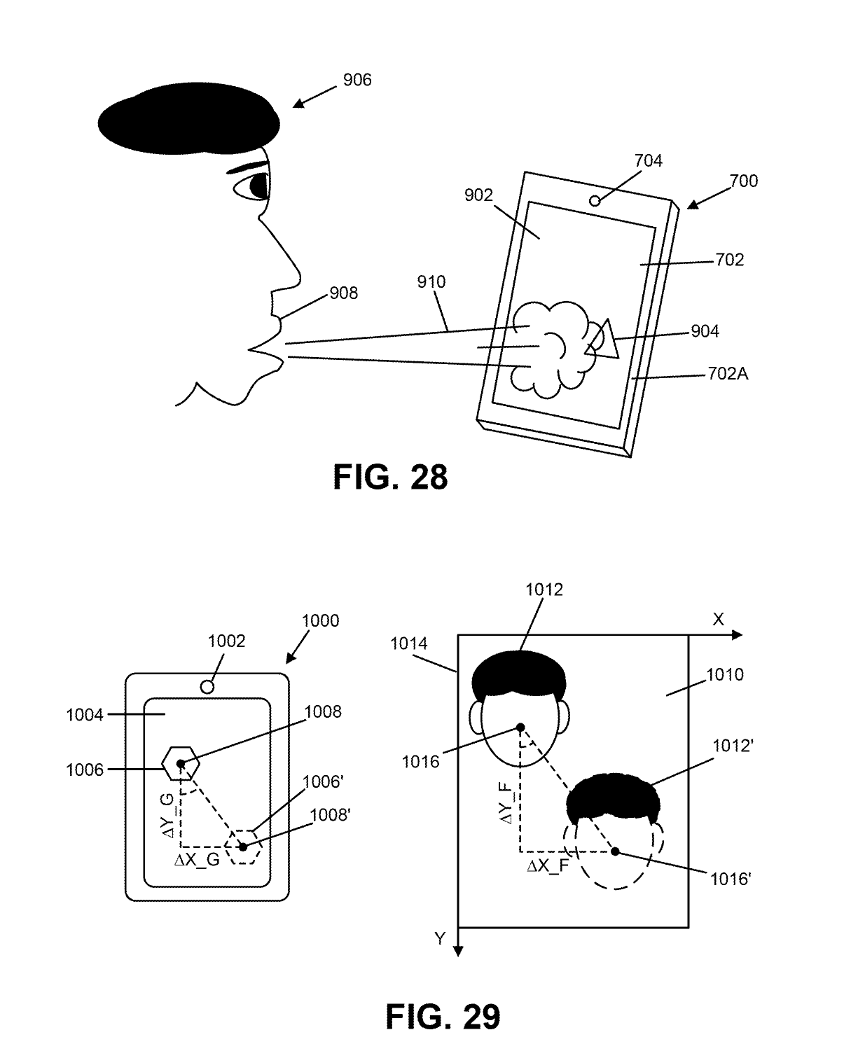

As shown in FIG. 28, the user 906 moves his mouth 908 to move the air stream towards his right side. As a result, the application program detects that the position of the air stream “touch” point is moving to the left side 702A of the display 702. The application program then performs the actions associated with the scrolling/moving gesture by moving the graphic object 904 to the new position of the air stream “touch” point. The scrolling/moving gesture is completed when no air stream is detected by the touch sensitive display 702.

In the embodiments described above, facial features are detected in the facial space to determine gestures performed by the user. In another embodiment, the movement of a user's face image is detected for determining gestures.

FIG. 29 shows a computing device 1000 having a camera 1002 and a screen 1004 displaying a graphic object 1006 thereon. Similar as described above, the camera 1002 captures images 1010 of the user. The computing device 1000 detects user's face image 1012 from the captured image 1010. For ease of illustration, facial features are not shown in FIG. 29.

A Cartesian coordinate system 1014 is defined for the captured image 1010 with the origin at the upper-left corner of the image 1010, x-axis increasing horizontally towards right, and y-axis increasing downwardly. However, any other coordinate system may alternatively be used.

After the face image 1012 is detected, the computing device 1000 calculates the location of a reference point 1016 (e.g., the geometric center) of the face image 1012, and monitors the movement of the face image 1012 in the captured images 1010 by monitoring the location change of the reference point 1016. As shown in FIG. 29, in the next captured image, the face image is moved to a different location 1012′. The computing device 1000 calculates the new location of the reference point 1016′, and then compares to the previous location of the reference point 1016 to calculate the location change ΔX_F along the x-axis and ΔY_F along the y-axis. If any of ΔX_F and ΔY_F is larger than a predefined threshold, a moving gesture is detected. As a result, the computing device 1000 proportionally moves the graphic object 1006 along the same direction to a new location 1006′ so that

ΔX_{—}G=c₃ΔX_{—}F,and

ΔY_{—}G=c₃ΔY_{—}F,

where ΔX_G represents the location change of center 1008 of the graphic object 1006 along the x-axis, ΔY_G represents the location change of center 1008 of the graphic object 1006 along the y-axis, and c₃ represents a predefined nonzero ratio.

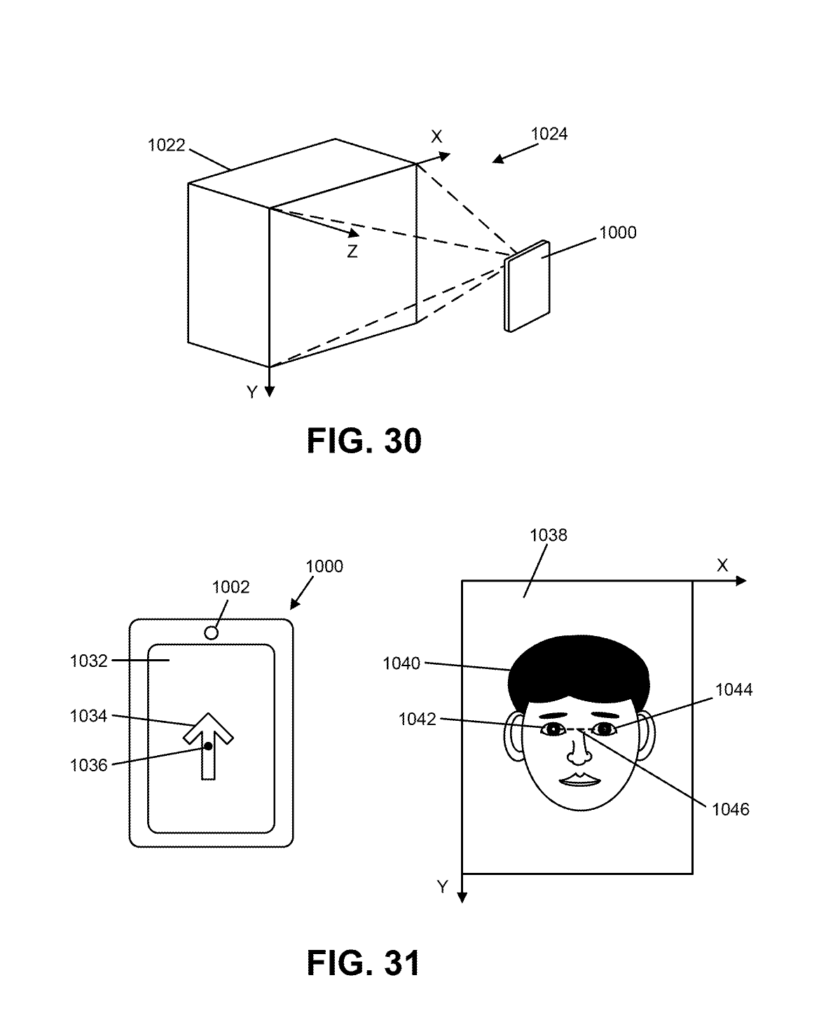

In yet another embodiment, the computing device uses the camera to detect the three-dimensional (3D) movement of the user's face, and determines 3D gesture therefrom. FIG. 30 shows a 3D space 1022 captured by the camera (not shown) of a computing device 1000. For ease of description, a 3D Cartesian coordinate system 1024 is defined for describing the 3D system, with the x-axis increasing horizontally towards right, y-axis increasing downwardly, and z-axis increasing towards the computing device 1000. However, any other 3D coordinate system may alternatively be used.

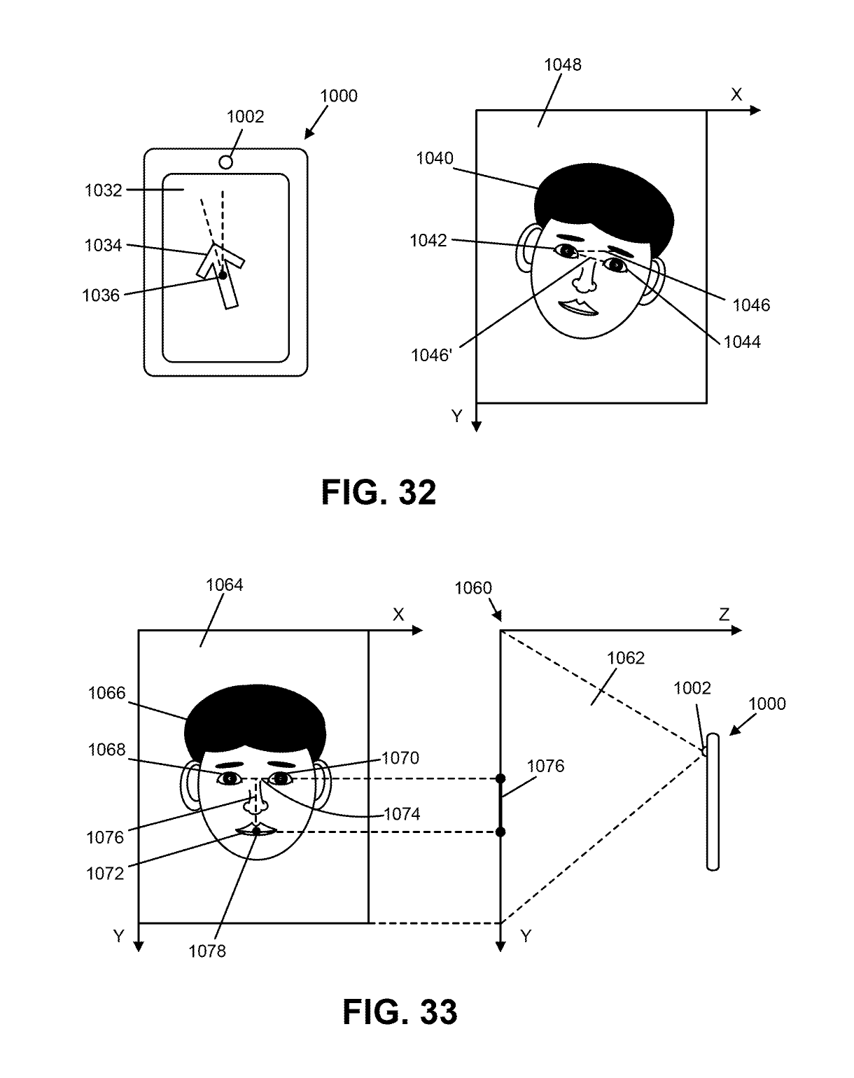

FIGS. 31 and 32 show a rotation gesture on the x-y plane by leaning the user's head (and therefore the user's face) about the z-axis. FIG. 31 shows a computing device 1000 comprising a camera 1002 and a screen 1032. An application program running in the computing device 1000 displays on the screen 1032 a graphic object 1034 having a rotation center 1036. The camera 1002 captures an image 1038 of a user within its field of view (not shown). The application program, by using the face recognition API, detects from the image 1038 the user's face 1040 and the facial features thereon. The application program uses two predefined facial features, which in this example are the user's eyes 1042 and 1044, as reference points, and calculates a line segment 1046 between the eyes 1042 and 1044.

As shown in FIG. 32, the camera 1002 of the computing device 1000 captures another image 1048 of the user after the user leans his head to his left. The application program, after detecting the user's face and facial features thereon, calculates the line segment 1046′ between the two eyes 1042 and 1044, and calculates the rotation angle R₁ between line segments 1046 and 1046′. If the rotation angle R₁ is larger than a predefined threshold, a rotation gesture is then determined. In response to the rotation gesture, the application program proportionally rotates the graphic object 1034 about its rotation center 1036 towards the direction opposite to that of the user's head by an angle

R₂=c₄R₁,

where c₄ is a predefined non-zero ratio.

FIGS. 33 to 36 show a pitch gesture on the y-z plane 1060 by nodding the user's head (and therefore the user's face) about the x-axis. FIG. 33 shows a side view of a computing device 1000 comprising a camera 1002 and a screen (not shown). Also referring to FIG. 35, an application program running in the computing device 1000 displays on the screen 1032 a 3D graphic object 1082. The camera 1002 captures an image 1064 of a user within its field of view 1062. The application program, by using the face recognition API, detects from the image 1064 the user's face 1066 and the facial features thereon. The application program uses three predefined facial features, which in this example are the user's eyes 1068, 1070 and the user's mouth 1072, as reference points, and determines a line segment 1074 between the eyes 1068 and 1070, and then calculates the distance H between the center 1078 of the user's mouth 1072 and the line segment 1074, i.e., the length of a line segment 1076 extending from the center of the user's mouth 1072 to the line segment 1074 with a 90° angle. For ease of illustration, the line segment 1076 is also shown on the y-axis of the y-z plan 1060. However, those skilled in the art will appreciate that this is only for illustrative purpose only, and the line segment 1076 is not necessarily required to be on the y-axis.

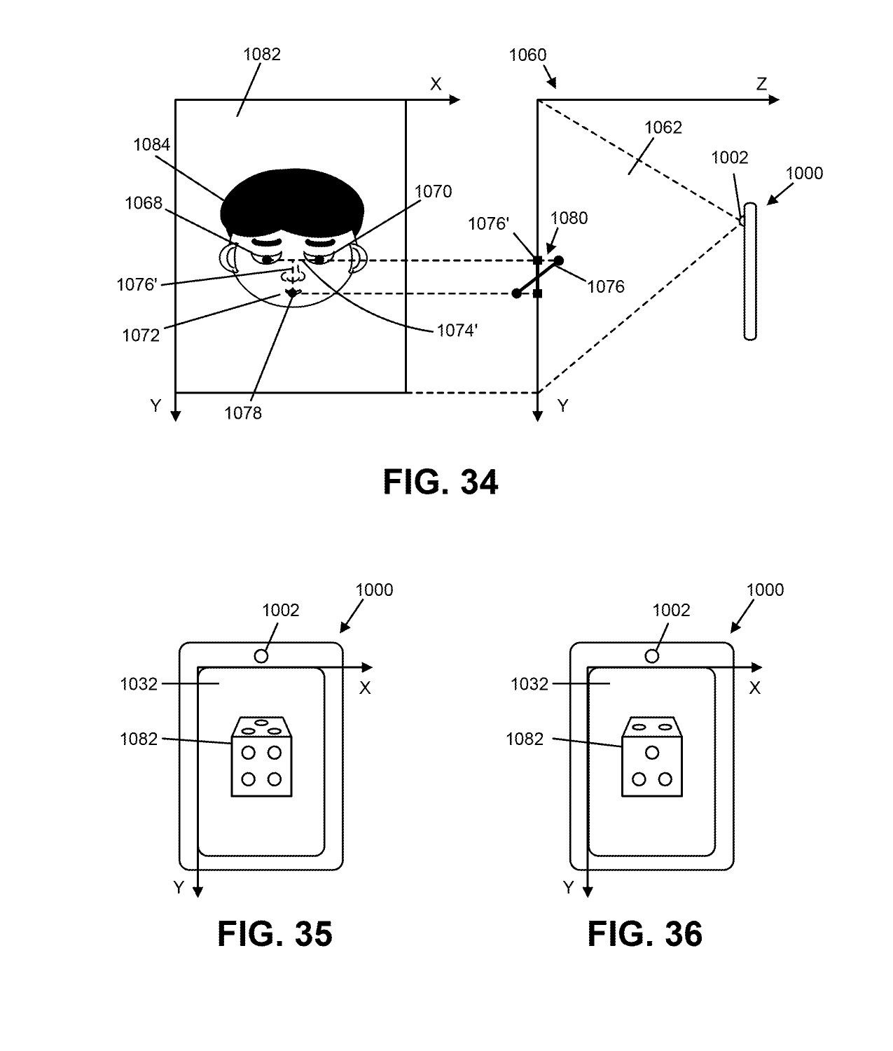

As shown in FIG. 34, the camera 1002 of the computing device 1000 captures another image 1082 of the user after the user nods down his head. The application program, after detecting the user's face and facial features thereon, determines a line segment 1074′ between the two eyes 1068 and 1070, and calculates the distance H′ between the center 1078 of the user's mouth 1072 and the line segment 1074′, i.e., the length of a line segment 1076′ extending from the center of the user's mouth 1072 to the line segment 1074′ with a 90° angle. For ease of illustration, the line segment 1076′ is also shown on the y-z plane.

It can be seen that, the originally calculated line segment 1076 is rotated in accordance with the user nodding down his head. The rotation angle P₁ of the user's head is then equal to the angle 1080 between line segments 1076 and 1076′. The application program calculates the angle P₁ by using line segments 1076 and 1076′. If the rotation angle P₁ is larger than a predefined threshold, a pitch gesture is then determined.

The application program determines the rotation direction by comparing the lengths of line segments 1074 and 1074′. If the length of line segment 1074′ is larger than that of line segment 1074, the user has nodded “down” his head (i.e., the user's forehead is rotating towards the camera 1002), and if the length of line segment 1074′ is smaller than that of line segment 1074, the user has nodded “up” his head (i.e., the user's forehead is rotating away from the camera 1002).

As shown in FIG. 36, the application program in response to the pitch gesture proportionally rotates the graphic object 1034 about the x-axis of the screen 1032 (which in this example is defined as the horizontal axis on the screen surface) by an angle

P₂=c₅P₁,

where c₅ is a predefined non-zero ratio.

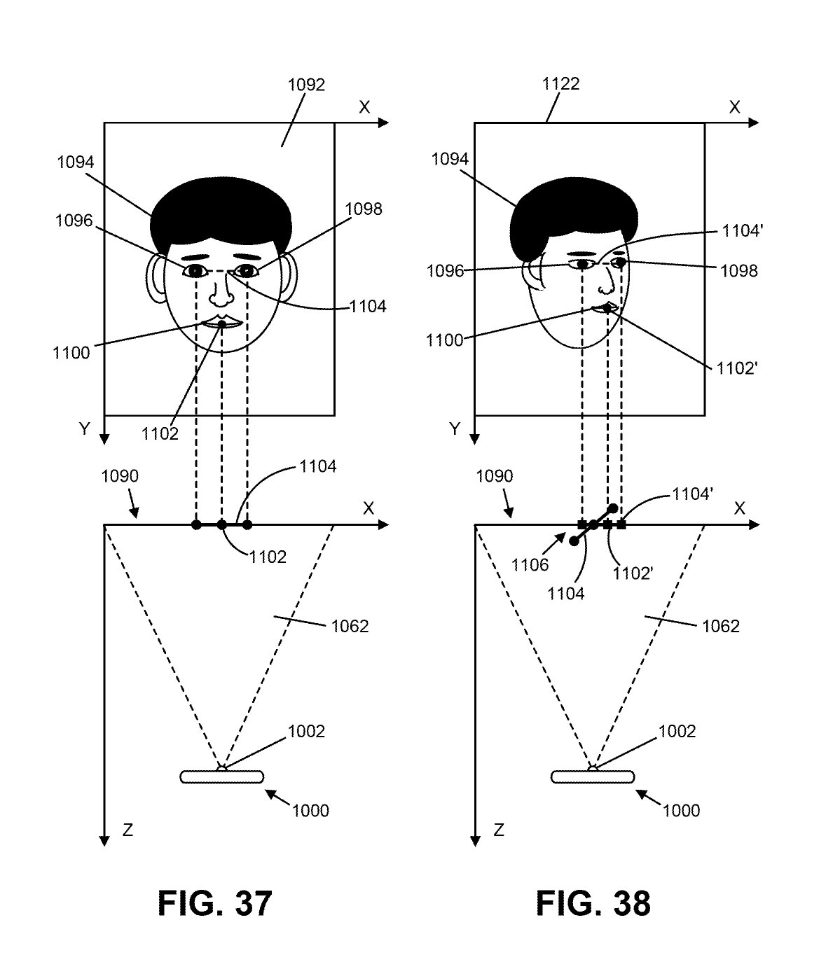

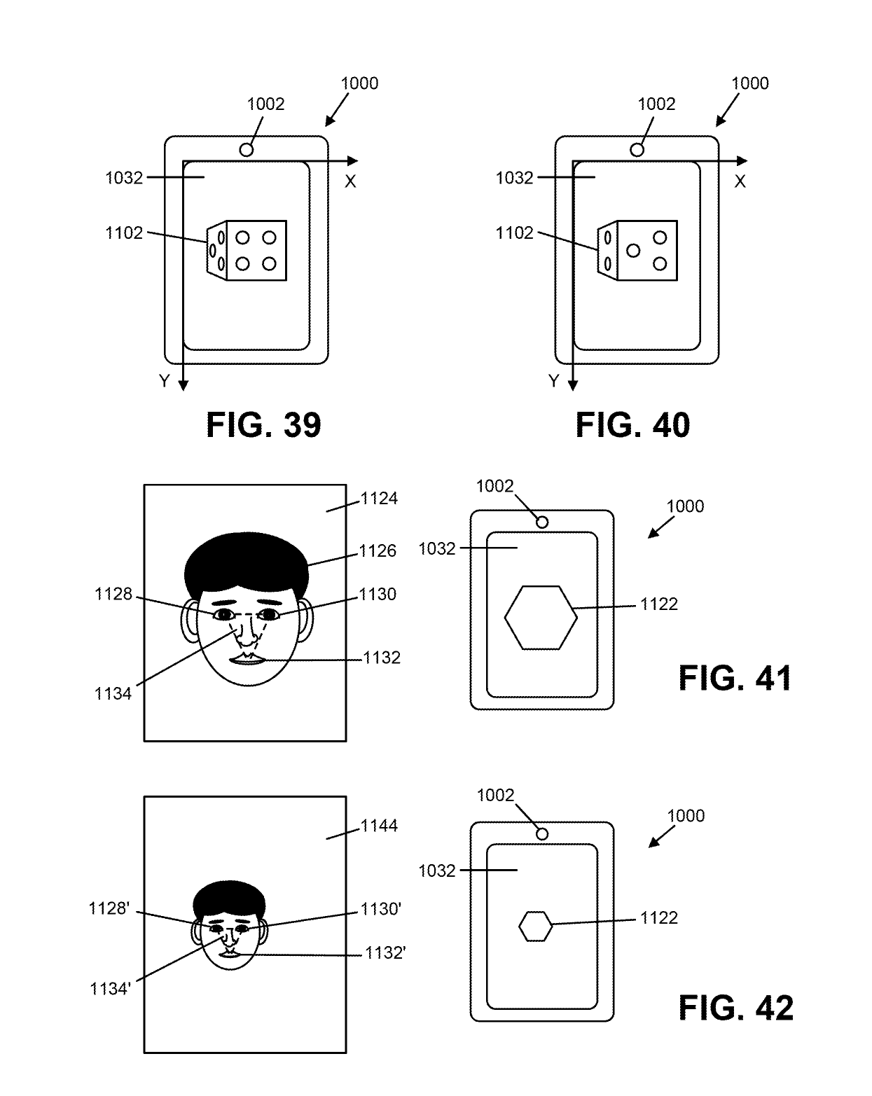

FIGS. 37 to 40 show a yaw gesture on the x-z plane 1090 by turning the user's head (and therefore the user's face) about the y-axis. FIG. 37 shows a top view of a computing device 1000 comprising a camera 1002 and a screen (not shown). Also referring to FIG. 39, an application program running in the computing device 1000 displays on the screen 1032 a 3D graphic object 1102. The camera 1002 captures an image 1092 of a user within its field of view 1062. The application program, by using the face recognition API, detects from the image 1092 the user's face 1094 and the facial features thereon. The application program uses three predefined facial features, which in this example are the user's eyes 1096, 1098 and the user's mouth 1100, as reference points. The application program calculates a line segment 1104 between the eyes 1096 and 1098, and determines the center 1102 of the mouth 1100. For ease of illustration, the line segment 1104 and the mouth center 1102 are also shown on the x-axis of the x-z plan 1090. However, those skilled in the art will appreciate that this is only for illustrative purpose only, and the line segment 1104 and mouth center 1102 are not necessarily required to be on the x-axis.

As shown in FIG. 38, the camera 1002 of the computing device 1000 captures another image 1122 of the user after the user turned his head. The application program, after detecting the user's face and facial features thereon, calculates a line segment 1104′ between the eyes 1096 and 1098, and determines the center 1102′ of the mouth 1100. For ease of illustration, the line segment 1104′ and the mouth center 1102′ are also shown on the x-z plane.

It can be seen that, the originally calculated line segment 1104 is rotated in accordance with the user turning his head. The rotation angle T₁ of the user's head is then equal to the angle 1106 between line segments 1104 and 1104′. The application program calculates the angle T₁ by using line segments 1104 and 1104′. If the rotation angle T₁ is larger than a predefined threshold, a yaw gesture is then determined.

The application program determines the rotation direction by comparing the positions of the mouth centers 1102 and 1102′. Comparing to the location of the mouth center 1102, if the location of current mount center 1102′ has moved closer to the user's right eye 1096, the user has turned his head towards his right side, and if the location of current mount center 1102′ has moved closer to the user's left eye 1098, the user has turned his head towards his left side.

As shown in FIG. 40, the application program proportionally rotates the graphic object 1102 about the y-axis of the screen 1032 (which in this example is defined as the vertical axis on the screen surface) by an angle

T₂=c₆T₁,

where c₆ is a predefined non-zero ratio.

FIGS. 41 and 42 show a zoom gesture performed by moving user's head along the z-axis. As shown in FIG. 41, an application program running in the computing device 1000 displays on the screen 1032 a graphic object 1122. The camera 1002 captures an image 1124 of a user within its field of view (not shown). The application program, by using the face recognition API, detects from the image 1124 the user's face 1126 and the facial features thereon. The application program uses three predefined facial features, which in this example are the user's eyes 1128, 1130 and the user's mouth 1132, as reference points. The application program determines a triangle 1134 formed by using the centers of the reference points 1128, 1130 and 1132 as the vertices thereof, and calculates the size of the triangle 1134. The user moves his head along the z-axis away from the camera 1002. As shown in FIG. 42, the camera 1002 of the computing device 1000 captures another image 1144 of the user. After the user's face and facial features thereon are detected, the application program determines a triangle 1134′ formed by using the centers of the reference points 1128′, 1130′ and 1132′ as the vertices thereof, and calculates the size of the triangle 1134′. If the size of the triangle 1134′ is smaller than that of the previously calculated triangle 1134 by an amount larger than a predetermined threshold (e.g., the size of the triangle 1134′ is smaller than that of the triangle 1134 by more than 2%), a zoom-out gesture is then determined. In response to the zoom-out gesture, the application program proportionally shrinks the size of the graphic object 1122, as shown in FIG. 42.

If the size of the triangle 1134′ is larger than that of the previously calculated triangle 1134 by an amount larger than a predetermined threshold (e.g., the size of the triangle 1134′ is larger than that of the triangle 1134 by more than 2%), a zoom-in gesture is then determined. In response to the zoom-in gesture, the application program proportionally enlarges the size of the graphic object 1122.

Those skilled in the art will appreciate that, in some alternative embodiments, the zoom gesture may also be determined by calculating the size of the face image.

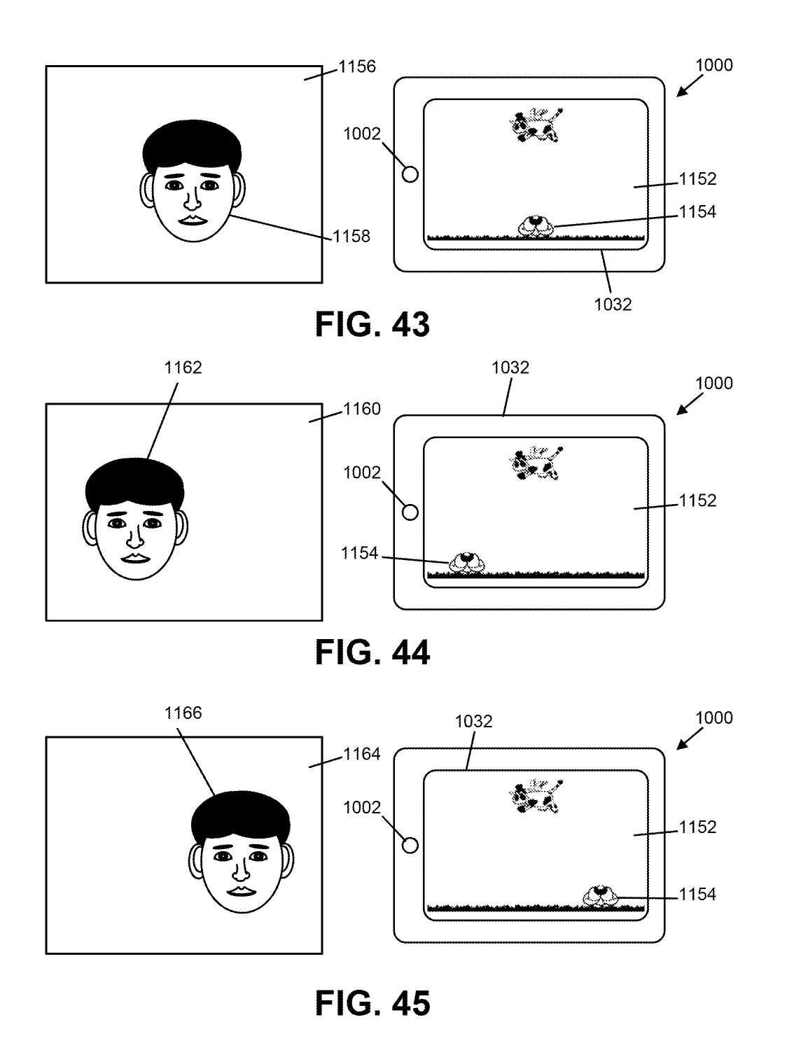

FIGS. 43 to 45 show a moving gesture performed by moving the user's head to different locations in the field of view of camera 1002. As shown in FIG. 43, an application program running in the computing device 1000 displays on the screen 1032 an image 1152 representing a game scene. The image 1152 comprises a graphic object 1154, a dog head in this example, which is controlled by the user by performing a moving gesture to control the movement of the graphic 1154 by moving his head in the field of view of camera 1002.

The camera 1002 captures an image 1156 of the user. The application program, by using the face recognition API, detects from the image 1156 the user's face 1158 and determines its location in the captured image 1156. As shown in FIG. 44, the camera 1002 captures another image 1160 of the user. The application program determines that the user's face 1162 has now moved to a different location in the captured image 1160. If the distance between the current location of the user's face 1162 and its previous location 1158 is larger than a predetermined threshold, which is the case in this example, a moving gesture is then determined, and the application program, in response to the moving gesture, proportionally moves the graphic object 1154 to a new location at the opposite direction (so that the graphic object 1154 is moved towards the same direction from the user's point of view).

Similarly in FIG. 45, the user further moves his head to another different location 1166 in the image 1164 captured by the camera 1002. After determining the moving gesture, the application program proportionally moves the graphic object 1154 to a new location.

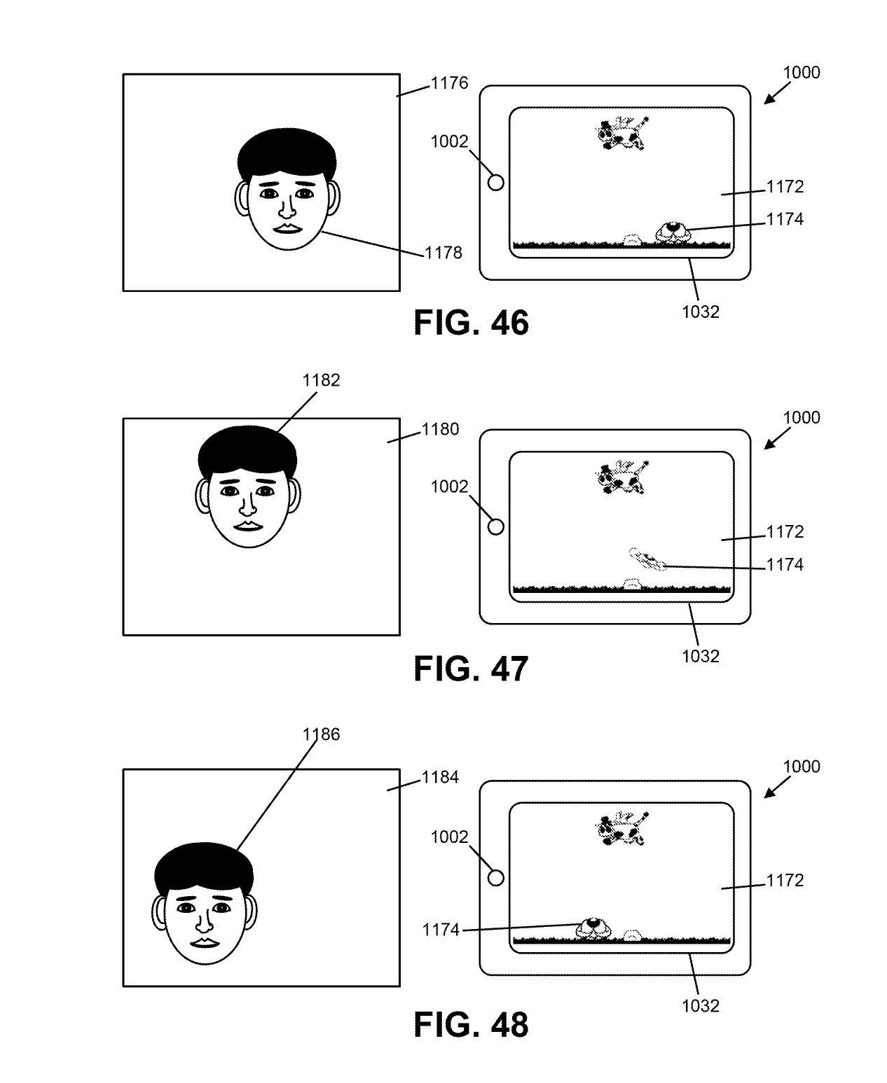

FIGS. 46 to 48 show another example of a moving gesture performed by moving the user's head to different locations in the field of view of camera 1002. An application program running in the computing device 1000 displays on the screen 1032 an image 1172 representing a game scene. The image 1172 comprises a graphic object 1174, which is a clog head in this example. The user moves his head to control the movement of the graphic object 1174. Similar as described above, the user moves his head in the field of view of the camera 1002. The camera 1002 captures images 1176, 1180 and 1184, respectively, and the application program detects the locations 1178, 1182 and 1186 of the user's face in the captured images 1176, 1180 and 1184, respectively. After determining a moving gesture, the application program in response moves the graphic object 1074 accordingly, so that the graphic object 1074 “jumps” over an obstacle in the scene presented on the screen.

Those skilled in the art will appreciate that the gestures described above and the application program's action in response to the gestures are for illustrative purpose only, and in various alternative embodiments, a gesture similar to that described above may trigger the application program to perform a different action in response thereto. For example, in an alternative embodiment, an e-book application program in response to a yaw gesture (user turning head to left or right) may turn the e-book display on the screen to the next or previous page.

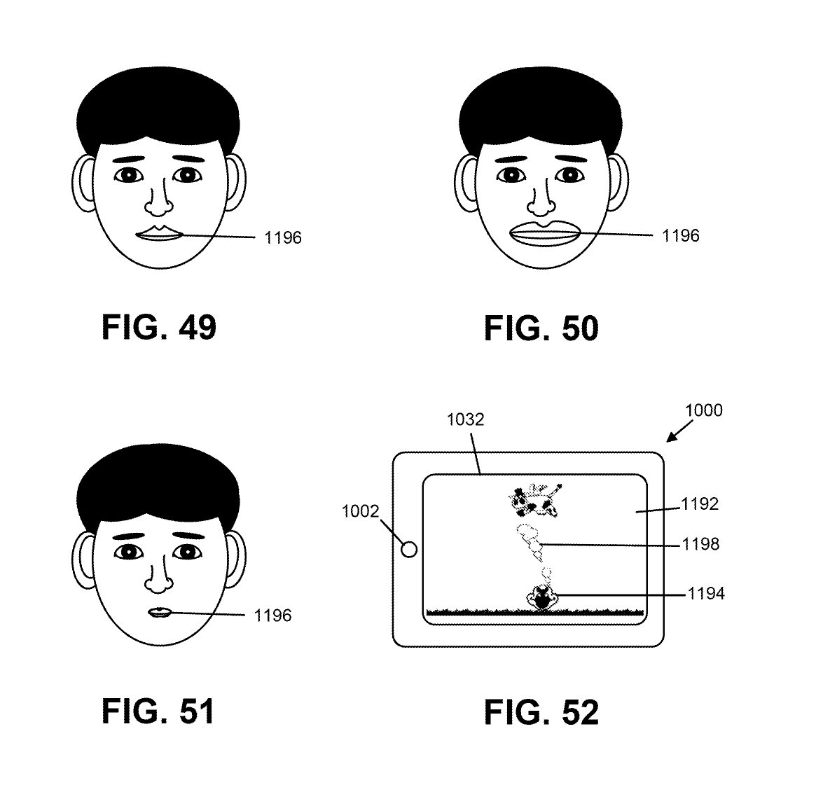

FIGS. 49 to 52 show a mouth gesture according to an alternative embodiment. An application program running in the computing device 1000 displays on the screen 1032 an image 1192 representing a game scene. The image 1192 comprises a graphic object 1194, a dog head in this example, which is controlled by the user using gestures. The user opens and closes his mouth to perform a mouth gesture. Similar as described above, the application program detects the mouth gesture, and in response, updates the image 1192 displayed on the screen 1032 to present an animation of a plurality of bubbles 1198 ejecting from the dog head 1194.

In embodiments described above, parameters of facial features or alternatively parameters of face image are used to determine gestures performed by the user. In an alternative embodiment, both parameters of facial features and parameters of face image are used to determine gestures.

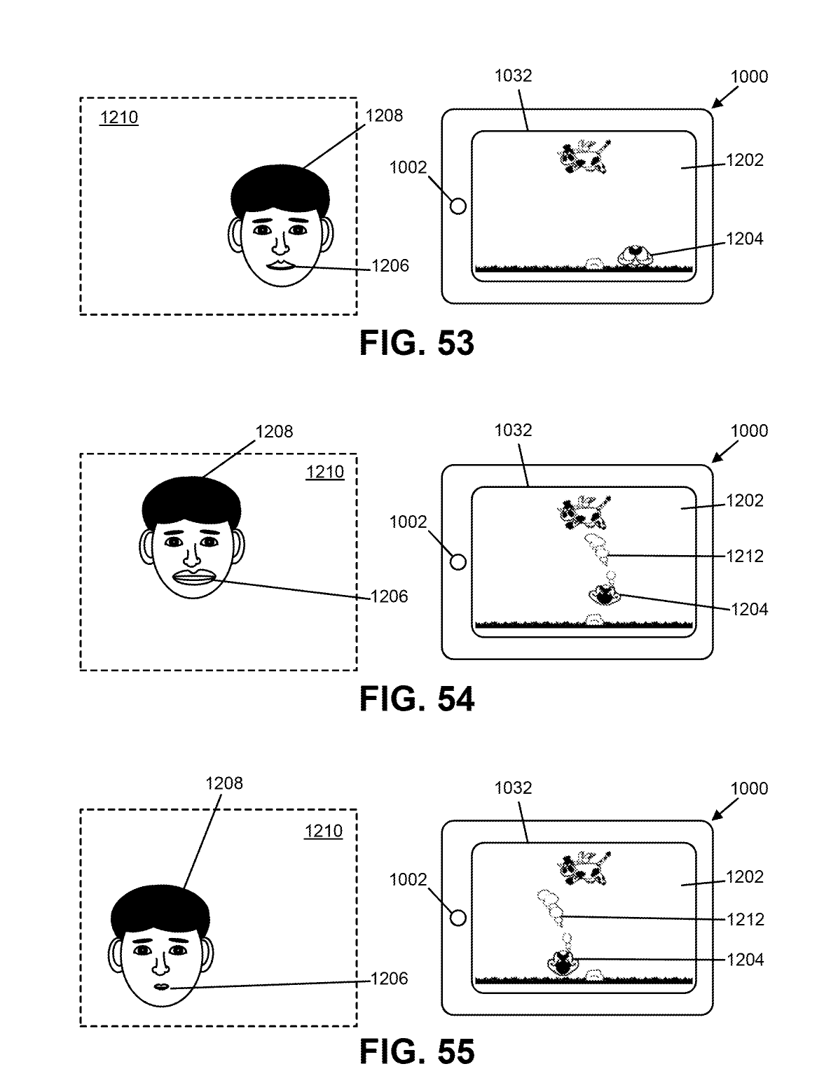

FIGS. 53 to 55 show an example of a move and bubbling ejecting gesture. An application program running in the computing device 1000 displays on the screen 1032 an image 1202 representing a game scene. The image 1202 comprises a graphic object 1204, a dog head in this example, which is controlled by the user using gestures. The user opens and closes his mouth 1206 while moves his head 1208 in the field of view 1210 of the camera 1002. The camera 1002 captures images of the user. The application program, via a face recognition API, detects the user's face 1208 and facial features thereon, including the mouse 1206. The application program detects the size change of the user's mouth 1206, and also detects the position change of the user's face 1208. A move and bubbling ejecting gesture is then detected in a manner similar to that described above. In response to the detected gesture, the application program moves the graphic object 1204 and at the same time animates a plurality of bubbles 1212 from the graphic object 1204.

Although the computing device 100, 700, or 1000 described above comprises other input devices such as keyboard (not shown) and/or mouse, in some alternative embodiments, the computing device 100, 700, or 1000 does not comprise these input devices.

In some alternative embodiments, the camera 104 or 704 may be a camera device physically separated from the computing device, but functionally couple thereto via a wired or wireless connection, such as USB, IEEE 1394, serial cable, WiFi, Bluetooth or the like.

Although the computing device 100 or 700 is described above as a portable computing device, in some alternative embodiments, the computing device 100 or 700 may be other type of computer device, such as a desktop computer.

Those skilled in the art will appreciate that the embodiments described above are for illustrative purposes only, and variations and modifications may be readily made without departing from the scope thereof as defined by the appended claims.

What is claimed is:

1. A method performed by a computing device for manipulating a graphic object presented on a display, the method comprising:
capturing images of a user by using an imaging device;
detecting the face image of the user in the captured images;
recognizing at least one facial feature in the face image;
calculating at least one parameter of said at least one facial feature; and
manipulating said graphic object based on the analysis of said at least one parameter of the at least one facial feature.

2. The method of claim 1 wherein said imaging device is located in proximity to the display.

3. The method of claim 2 wherein said at least one facial feature is selected from the group of eye, eyebrow, nose, mouth and ear.

4. The method of claim 3 wherein said at least one parameter of the at least one facial feature is selected from the group of shape, size, angle and position of the at least one facial feature.

5. The method of claim 4 wherein said computing device is a portable computing device.

6. The method of claim 5 wherein said imaging device is integrated in the portable computing device.

7. The method of claim 6 wherein said computing device is a phone.

8. The method of claim 6 wherein said computing device is a tablet.

9. The method of claim 6 wherein said computing device is a game console.

10. The method of claim 1 further comprising:
calculating at least one parameter of said face image; and
manipulating said graphic object based on the analysis of said at least one parameter of said face image and said at least one parameter of the at least one facial feature.

11. A computing device, comprising:
an imaging device;
a screen; and
a processing unit functionally coupling to said imaging device and said screen; said processing unit executing code for
displaying on said screen an image comprising a graphic object;
instructing said imaging device to capture images of a user;
detecting the face image of the user in the captured images;
recognizing at least one facial feature in the face image;
calculating at least one parameter of said at least one facial feature; and
manipulating said graphic object based on the analysis of said at least one parameter of the at least one facial feature.

12. The computing device of claim 11 wherein said imaging device is located in proximity to the display.

13. The computing device of claim 12 wherein said at least one facial feature is selected from the group of eye, eyebrow, nose, mouth and ear.

14. A computing device of claim 13 wherein said at least one parameter of the at least one facial feature is selected from the group of shape, size, angle and position of the at least one facial feature.

15. A computing device of claim 14 wherein said computing device is a portable computing device.

16. A computing device of claim 15 wherein said imaging device is integrated in the portable computing device.

17. A computing device of claim 16 wherein said computing device is a phone.

18. A computing device of claim 16 wherein said computing device is a tablet.

19. A computing device claim 16 wherein said computing device is a game console.

20. The method of claim 11 further comprising:
calculating at least one parameter of said face image; and
manipulating said graphic object based on the analysis of said at least one parameter of said face image and said at least one parameter of the at least one facial feature.

21. A non-transitory computer readable medium having computer executable program for detecting a gesture, the computer executable program comprising:
computer executable code for instructing an imaging device to capture images of a user;
computer executable code for detecting the face image of the user in the captured images;
computer executable code for recognizing at least one facial feature in the face image;
computer executable code for calculating at least one parameter of said at least one facial feature; and
computer executable code for manipulating said graphic object based on the analysis of said at least one parameter of the at least one facial feature.

22. A non-transitory computer readable medium of claim 21 wherein said at least one facial feature is selected from the group of eye, eyebrow, nose, mouth and ear.

23. A non-transitory computer readable medium of claim 22 wherein said at least one parameter of the at least one facial feature is selected from the group of shape, size, angle and position of the at least one facial feature.

24. A non-transitory computer readable medium of claim 23 further comprising:
computer executable code for calculating at least one parameter of said face image; and
computer executable code for manipulating said graphic object based on the analysis of said at least one parameter of said face image and said at least one parameter of the at least one facial feature.
